(19) United States
(12) Patent Application Publication
(10) Pub. No.: US 2011/0304528 A1
(43) Pub. Date: Dec. 15, 2011

(54) LIQUID CRYSTAL DISPLAY DEVICE

(76) Inventors: Mitsuhiro Murata, Osaka (JP); Shoichi Ishihara, Osaka (JP); Shuichi Kozaki, Osaka (JP); Takehisa Sakurai, Osaka (JP); Tadashi Ohtake, Osaka (JP)

(21) Appl. No.: 13/202,671

(22) PCT Filed: Mar. 8, 2010
(86) PCT No.: PCT/JP2010/053811

§ 371 Date: Aug. 22, 2011

(30) Foreign Application Priority Data
May 29, 2009 (JP) 2009-130186
Aug. 24, 2009 (JP) 2009-193031
Jan. 15, 2010 (JP) 2010-006691

(51) Int. Cl. G09G 3/36

(52) U.S. Cl. 345/102

(57) ABSTRACT

The present invention provides a liquid crystal display device in which viewing angle characteristics are improved without impairing transmittance. A liquid crystal display device of the present invention, comprises:
a liquid crystal display panel including a liquid crystal layer and a pair of substrates sandwiching the liquid crystal layer; and
a backlight unit disposed on a back side of the liquid crystal display panel,
one of the pair of substrates including a pair of comb-shaped electrodes each having comb teeth, the comb teeth of one of the pair of comb-shaped electrodes and the comb teeth of the other of the pair of comb-shaped electrodes being disposed alternately and spaced apart from each other,
the liquid crystal layer including liquid crystal molecules with positive dielectric anisotropy,
the liquid crystal molecules being aligned in a direction perpendicular to a surface of the one of the pair of substrates when no voltage is applied, and
   a difference between a proportion of liquid crystal molecules aligned in directions at angles of from 20° to 60° and angles of from −60° to −20° to the surface of the one of the substrates during white display relative to all liquid crystal molecules contained in the liquid crystal layer, and a proportion of light emitted in directions at angles of from 20° to 60° and angles of from −60° to −20° to the surface of the one of the substrates relative to all light emitted from the backlight unit and entering the liquid crystal display panel being less than 20%.

### TECHNICAL FIELD

The present invention relates to a liquid crystal display device. More particularly, the present invention relates to a liquid crystal display device suitably used as a liquid crystal display device with a display mode for imparting vertical alignment as the initial alignment to liquid crystal molecules, and controlling the liquid crystal molecules by an electric field (for example, a transverse electric field) generated.

### BACKGROUND ART

Liquid crystal display devices have been widely used in various fields because of its characteristics such as thinness, light weight, and low power consumption. Liquid crystal display devices are generally provided with backlight units for display. The backlight units emit light, and the light is controlled by liquid crystal.

Sunlight may be used as light sources for display by reflecting the sunlight. However, liquid crystal display devices which are mainly used indoors such as word processors, laptop personal computers, and on-vehicle display devices, and liquid crystal display devices which are used outdoors and constantly needing a certain brightness require backlight units including light sources.

Examples of members of backlight units include, in addition to light sources, reflective sheets, diffusion sheets, and prism sheets. Edge light backlight units and direct backlight units are generally known as backlight units.

Direct backlight units include light sources arranged to face liquid crystal display panels. Light emitted from the light sources linearly passes through optical sheets, such as diffusion sheets and prism sheets, arranged on the light sources, and goes out from the backlight units as display light.

Edge light backlight units have light guide plates. Light emitted from the light sources enters the light guide plates from the side faces of the light guide plates, and is reflected and diffused. The resulting light is then emitted as planar light from main faces of the light guide plates. The light further passes through optical sheets, such as diffusion sheets and prism sheets, and goes out as display light from the backlight units. Liquid crystal display devices including small screens can perform display with low power consumption because of their small number of light sources. Therefore, edge light backlight units suitable for realizing thin-profile devices are commonly used in such liquid crystal display devices.

Liquid crystal display devices need to have viewing angle characteristics such that the same display can be observed when a display screen is viewed in any direction. Liquid crystal molecules that switches ON and OFF of liquid crystal display have birefringence and each have a rod shape. Therefore, light traveling in a front direction and light traveling in an oblique direction, relative to the display screen, are converted in different ways, which causes deterioration of viewing angle characteristics.

Technologies for improving viewing angle characteristics of liquid crystal display devices have been studied. Patent Document 1, for example, discloses a means for compensating a viewing angle in an oblique direction at an angle of 45° relative to a substrate using a polarized light separator. The polarized light separator includes a birefringence medium and a cholesteric layer which are set in certain conditions. Patent Document 2, for example, discloses a means for compensating a viewing angle in an oblique direction by arrangement of an anisotropic scattering film having scattering anisotropy on a display face of a display device.

However, the means disclosed in Patent Document 1 causes reduction in transmittance because of its three polarizer films. Further, the means disclosed in Patent Documents 2 causes character blurring because display is likely to be affected by ambient light due to a scattering layer with anisotropy arranged on a display face. In addition, character bleeding is caused due to the scattering layer. Technologies for improving viewing angle characteristics without using a particular compensation layer and a particular scattering layer are not developed yet. In this respect, there is room for improvement.

### [Patent Document 1]

Japanese Kokai Publication No. Hei-11-64841

### [Patent Document 2]

Japanese Kokai Publication No. 2004-145182

### DISCLOSURE OF THE INVENTION

With the foregoing in view, it is an object of the present invention to provide a liquid crystal display device in which viewing angle characteristics are improved without impairing transmittance.

Display modes of liquid crystal display devices are classified according to methods for aligning liquid crystal. Examples of conventionally known display modes of liquid crystal display devices include a TN (Twisted Nematic) mode, a VA (Vertical Alignment) mode, an IPS (In-Plane Switching) mode, and an OCB (Optically self-Compensated Birefringence) mode.

Alternately, a display mode has been recently proposed in which nematic liquid crystal with positive dielectric anisotropy is used as a liquid crystal material, the nematic liquid crystal is vertically aligned to provide and maintain high contrast, and in addition, a transverse electric field is generated using a pair of comb-shaped electrodes to control alignment of liquid crystal molecules. How the present invention is completed will be described with reference to the above-mentioned mode. The present invention is not limited to such a mode.

In the mode, liquid crystal molecules are aligned along a transverse electric field generated in an arch shape between a pair of comb-shaped electrodes arranged on one and the same substrate. According to this, distribution of directors has a symmetry along a transverse electric field to have an arch shape, and the directors form bend alignment in a transverse direction. Each of the directors is a unit vector in an alignment direction of an axis of each of the liquid crystal molecules in a liquid crystal layer. As a result, even if a display face is observed in an oblique direction, display having the same display quality as that of display observed in a front direction can be visually recognized.

The present inventors noted that liquid crystal display devices with such modes achieve excellent contrast and excellent viewing angle characteristics, and made various investigations on methods for achieving high transmittance in the liquid crystal display devices with such a mode.

First, the present inventors noted a backlight unit, and have made various investigations on distribution of light emitted from a common backlight unit. The inventors found that luminance is different at polar angles of from 0° to ±90° in the distribution of light emitted from a common backlight unit, when a front direction of a panel plane is defined as a polar angle of 0°. The inventors further noted that it is preferred that a proportion of light flux in the range of polar angles of from 0° to ±60° relative to all emitted light is 95% in distribution of light emitted from such a backlight unit, and that the distribution is adjusted so that extreme change in luminance in the range of polar angles of from 0° to ±60° is not observed. Such investigations are performed based on the assumption that display in the range of polar angles of from 0° to ±60° is likely to be observed by a viewer. Accordingly, an increase in the proportion of light flux and a decrease in angular dependence in such a range allow efficient improvements in luminance perceived by a viewer and viewing angle characteristics.

The present inventors noted features of such modes and the distribution of light emitted from a backlight unit, and further made intensive investigations on them. Particularly, the present inventors paid attention to distribution of light emitted from a backlight unit in the range of polar angles of from ±20° to ±60°. As a result, the present inventors found that after the proportion of distribution of light emitted from a backlight unit in the range of polar angles of from ±20° to ±60° is determined, a proportion of director distribution in the same range described above in the above-mentioned mode is close to the proportion of distribution of light emitted from a backlight unit, which achieve high luminance and a widened viewing angle.

When the distribution of light emitted from a backlight unit has high proportion of light focusing in a front direction and a direction in the vicinity of the front direction, that is, in a polar angle of up to ±20°, less turbulence of the compensation of liquid crystal is found. However, an amount of light elements viewed in an oblique direction relative to a panel plane is extremely reduced compared to that viewed in the front direction. Therefore, display may not be observed in a dark panel when the display device is viewed in an oblique direction. On the other hand, in the case where the proportion of light in a direction at a polar angle of higher than ±20° is high, luminance viewed in the front direction is lowered.

From the standpoint of the refractive index of liquid crystal molecules, in the case where a backlight unit is used, birefringence is observed in light elements passing through rod-shaped liquid crystal molecules when the light elements are viewed in an oblique direction relative to a panel plane. Specifically, when liquid crystal molecules are sandwiched between polarizers disposed on the respective uppermost surface and lowermost surface of the panel in a cross arrangement to form an angle of 90° each other, transmittance of the light elements viewed in the oblique direction modulates relative to transmittance of light elements in which no optical birefringence is observed when the panel is directly viewed in the front direction.

Light elements with polar angles of from ±20° to ±60° out of light elements in which birefringence due to liquid crystal is observed when viewed in an oblique direction mainly cause the modulation of transmittance. This is because birefringence generated in light transmitting through directors at polar angles of from 0° to ±20° is not so large, which causes less modulation, and the proportion of light flux of light transmitting through directors at polar angles of from ±60° to ±90° is low, and all of the light is reflected on a glass substrate included in the panel by total internal reflection, whereby the light is less affected. That is, if the proportion of light flux of birefringent light in an oblique direction is similar to a proportion of liquid crystal molecules at polar angles of from ±20° to ±60° in director distribution of all liquid crystal molecules, less modulation is generated.

FIGS. 17-1 to 17-3 are conceptual views showing a state of light transmitting through a liquid crystal molecule in which the initial inclination is vertical alignment. FIG. 17-1 is a view in the case where no voltage is applied (during black display), FIG. 17-2 is a view in the case where an intermediate voltage is applied (during gray display), and FIG. 17-3 is a view in the case where a voltage is applied (during white display). As shown in FIGS. 17-1 to 17-3, when a voltage is applied to a rod-shaped liquid crystal molecule 10 in which the initial inclination is vertical alignment, the inclination of the liquid crystal molecule differ in cases, that is, the case where no voltage is applied, the case where an intermediate voltage is applied, and the case where a voltage is applied. Particularly, if an approximately intermediate voltage is applied to the liquid crystal molecule 10, the length of an optical path of light in a longitudinal direction of the liquid crystal molecule 10 is increased when light in an oblique direction (at polar angles of from ±20° to ±60° enters the liquid crystal layer. Here, birefringence is a product of a refractive-index difference Δn and a distance d. Therefore, when a panel plane is viewed in an oblique direction, the particularly large birefringence is observed in the case where an intermediate voltage is applied. That is, the transmittance in a front direction is increased because a birefringence in an oblique direction is large. As a result, the difference between luminance in a front direction and luminance in an oblique direction is increased when an approximately intermediate voltage is applied.

When the amount of light in an oblique direction shown by a dashed line arrow in FIG. 17-2 is increased, the birefringence in such a direction is increased. The present inventors found that, in order to avoid such cases, it is preferred to adjust the direction of the director of the liquid crystal molecule and the number of optical paths of light, and that a distribution amount of the director of the liquid crystal molecule and a distribution amount of light emitted from a backlight unit are set to be the same, which allows suppression of birefringence in an oblique direction.

FIG. 18 is a conceptual view of a mode including liquid crystal molecules oriented in five different directions. In FIG. 18, a total of five paths of light passing through the respective five liquid crystal molecules 10 are represented by solid line arrows. FIG. 18 shows that the light is adjusted to take the shortest distance such that no birefringence is generated, which suppresses the generation of floating luminance in an oblique direction. In such a case, when two light represented by dashed line arrows are added, birefringence is generated in directions represented by the dashed line arrows. Adjustment of a proportion of director distribution of liquid crystal in the range of from ±20° to ±60° to a proportion of distribution of light in the same range emitted from a backlight unit is to allow the optimal light for compensation to pass through each liquid crystal molecule.

As a result, the present inventors admirably solved the above-mentioned problems, leading to completion of the present invention.

That is, the present invention is a liquid crystal display device, comprising:

a liquid crystal display panel including a liquid crystal layer and a pair of substrates sandwiching the liquid crystal layer; and

a backlight unit disposed on a back side of the liquid crystal display panel,

one of the pair of substrates including a pair of comb-shaped electrodes each having comb teeth, the comb teeth of one of the pair of comb-shaped electrodes and the comb teeth of the other of the pair of comb-shaped electrodes being disposed alternately and spaced apart from each other,

the liquid crystal layer including liquid crystal molecules with positive dielectric anisotropy,

the liquid crystal molecules being aligned in a direction perpendicular to a surface of the one of the pair of substrates when no voltage is applied, and

a difference between a proportion of liquid crystal molecules aligned in directions at angles of from 20° to 60° and angles of from −60° to −20° to the surface of the one of the substrates during white display relative to all liquid crystal molecules contained in the liquid crystal layer, and a proportion of light emitted in directions at angles of from 20° to 60° and angles of from −60° to −20° to the surface of the one of the substrates relative to all light emitted from the backlight unit and entering the liquid crystal display panel being less than 20%.

The liquid crystal display device of the present invention includes a liquid crystal display panel including a liquid crystal layer and a pair of substrates sandwiching the liquid crystal layer, and a backlight unit disposed on a back side of the liquid crystal display panel. The liquid crystal layer is filled with liquid crystal molecules whose alignment is controlled by applying a certain voltage. The pair of substrates are provided with lines, electrodes, semiconductor devices, and the like. With such substrates, a voltage is applied to the liquid crystal layer, which controls alignment of the liquid crystal molecules. Further, polarizers are formed on the pair of substrates, which allows the liquid crystal layer to control light transmission and light blocking. The backlight unit essentially includes a light source, and is provided with optical members such as a lens sheet, a diffusion sheet, a reflective sheet, and a light guide plate. The backlight unit is disposed on a back face side of the liquid crystal display panel and emits light to the liquid crystal display panel.

The one of the pair of substrates includes a pair of comb-shaped electrodes each having comb teeth. The comb teeth of one of the pair of comb-shaped electrodes and the comb teeth of the other of the pair of comb-shaped electrodes are disposed alternately and spaced apart from each other. The term “comb-shaped” as used herein refers to a shape basically composed of a handle portion as a trunk and a comb-teeth portion protruded from the handle portion. An electric field is, for example, an arch-shaped transverse electric field when an electric potential difference is given between the pair of comb-shaped electrodes. The liquid crystal molecules are aligned according to the direction of such an electric field, and therefore display in a front direction and display in an oblique direction, relative to a substrate surface, are the same as each other.

The liquid crystal layer includes liquid crystal molecules with positive dielectric anisotropy (As). Such liquid crystal molecules are aligned in the same direction as that of the electric field by applying a certain voltage to the liquid crystal layer. As a result, for example, the liquid crystal molecules show transverse bend alignment. The positive dielectric anisotropy (Δ∈) preferably satisfies 14<Δ∈<23 under a general driving method. That is, it is preferred that the liquid crystal display device includes a source line for supplying a signal voltage to one of the pair of comb-shaped electrodes, wherein the positive dielectric anisotropy Δ∈ is 14<Δ∈<23.

Source-polarity-inversion driving by a double source in which two source lines are used for one pixel doubles a dynamic range applied to liquid crystal (for example, when a source voltage is 7 V, 14 V can be applied by using the double source). In the case of using such a means, the Δ∈ is preferably 2.0 to 11.5. That is, it is preferred that the liquid crystal display device includes a first source line for supplying a signal voltage and a second source line for supplying a signal voltage, wherein a signal voltage is supplied to one of the pair of comb-shaped electrodes through the first source line, and a signal voltage is supplied to the other of the pair of comb-shaped electrodes through the second source line, the signal voltage supplied through the first source line and the signal voltage supplied through the second source line have polarities opposite to each other, and the positive dielectric anisotropy Δ∈ is 2.0<Δ∈<11.5.

The liquid crystal molecules are aligned in a direction perpendicular to a surface of the one of the pair of substrates in a state where no voltage is applied (hereinafter referred to simply as “vertical alignment”). Thus, the initial alignment of the liquid crystal molecules is adjusted, which efficiently blocks light for performing black display. In order to vertically align the liquid crystal molecules in a state where no voltage is applied, a vertical alignment film is disposed on a surface, which is in contact with the liquid crystal layer, of one or both of the pair of substrates. The terms “vertical” and “perpendicular” as used herein mean “substantially vertical to each other” and “substantially perpendicular to each other” in addition to “completely vertical to each other” and “completely perpendicular to each other”. Here, if one line is perpendicular to another line, they preferably form an angle of 90±4°. If the angle is less than 86° or exceeds 94°, contrast may decrease.

Accordingly, according to the liquid crystal display device of the present invention, the liquid crystal molecules are vertically aligned in a state where no voltage is applied, which achieves high contrast. Further, the liquid crystal molecules are transversely aligned to form bend alignment in a state where a voltage is applied, which achieves a wider viewing angle.

The difference between the proportion of liquid crystal molecules aligned in directions at angles of from 20° to 60° and angles of from −60° to −20° to the surface of the one of the substrates to all liquid crystal molecules contained in the liquid crystal layer during white display, and the proportion of light emitted in directions at angles of from 20° to 60° and angles of from −60° to −20° to the surface of the one of the substrates relative to all light emitted from the backlight unit and entering the liquid crystal display panel is less than 20%. The term “white display” as used herein means display where the maximum luminance is observed when a display screen is observed in a front direction relative to a substrate surface. As mentioned above, the proportion of director distribution of liquid crystal molecules in directions at polar angles of from ±20° to ±60° is close to the proportion of distribution of light emitted from a backlight unit in directions at polar angles of from ±20° to ±60°. Thereby, viewing angle characteristics providing display that is viewed similarly both in a front direction and in an oblique direction, and high luminance are achieved.

It is preferred that the proportion of distribution of light emitted from a backlight unit in the directions at polar angles of from ±20° to ±60° 40 to 51% in backlight distribution of light emitted from the backlight unit. It is preferred that the difference between the proportion of liquid crystal molecules aligned in directions at angles of from 20° to 60° and angles of from −60° to −20° to the surface of the one of the substrates to all liquid crystal molecules contained in the liquid crystal layer during white display, and the proportion of light emitted in directions at angles of from 20° to 60° and angles of from −60° to −20° to the surface of the one of the substrates relative to all light emitted from the backlight unit and enter the liquid crystal display panel is less than 15%, and more preferably less than 13%.

The configuration of the liquid crystal display device according to the present invention is not especially limited as long as the above-mentioned components are essentially comprised. The liquid crystal display device may or may not comprise other components.

### EFFECT OF THE INVENTION

According to the liquid crystal display device of the present invention, a high contrast ratio and excellent viewing angle characteristics are achieved, and in addition, high transmittance is achieved.

### BRIEF DESCRIPTION OF THE DRAWINGS

FIG. 1 is a perspective view schematically showing a liquid crystal display device in accordance with Embodiment 1.

FIG. 2-1 is a cross-sectional view schematically showing the liquid crystal display device in accordance with Embodiment 1, where no voltage is applied to a liquid crystal layer.

FIG. 2-2 is a cross-sectional view schematically showing the liquid crystal display device in accordance with Embodiment 1, where a voltage is applied to a liquid crystal layer.

FIG. 3-1 is a cross-sectional view schematically showing the liquid crystal display device in accordance with Embodiment 1. FIG. 3-1 shows director distribution and distribution of light emitted from a backlight unit, during white display, and particularly shows the entire director distribution.

FIG. 3-2 is a cross-sectional view schematically showing the liquid crystal display device in accordance with Embodiment 1, FIG. 3-2 shows director distribution during white display and the distribution of light emitted from the backlight unit, and particularly shows distribution of directors in directions at polar angles of from ±20° to ±60°.

FIG. 4 is a graph showing the distribution of light emitted from the backlight unit included in the liquid crystal display device in accordance with Embodiment 1. The distribution is represented by the relationship between a polar angle and luminance.

FIG. 5 is a conceptual view created by overlaying the distribution of directors in directions at polar angles of from ±20° to ±60° on the distribution of light emitted from the backlight unit in directions at polar angles of from ±20° to ±60°.

FIG. 6 is a cross-sectional view schematically showing a backlight unit included in a liquid crystal display device in accordance with Embodiment 2.

FIG. 7 is a graph showing distribution of light emitted from the backlight unit included in the liquid crystal display device in accordance with Embodiment 2. The distribution is represented by the relationship between a polar angle and luminance.

FIG. 8 is a cross-sectional view schematically showing a backlight unit included in a liquid crystal display device in accordance with Embodiment 3.

FIG. 9 is a graph showing distribution of light emitted from the backlight unit included in the liquid crystal display device in accordance with Embodiment 3. The distribution is represented by the relationship between a polar angle and luminance.

FIG. 10 is a graph containing curves of distribution of light emitted from the backlight units included in the respective liquid crystal display devices in accordance with Embodiments 1 to 3. The distribution is represented by the relationship between a polar angle and luminance.

FIG. 11 is a graph showing a ratio of a gradation value at an oblique direction to a gradation value at a front direction. The measurements are performed on a sample (I) every 10° in the range of from a front direction (a direction at a polar angle of 0°) to a direction at a polar angle of 60°.

FIG. 12 is a graph showing a ratio of a gradation value in an oblique direction to a gradation value in a front direction. The measurements are performed on a sample (II) every 10° in the range of from the front direction (a direction at a polar angle of 0°) to the direction at a polar angle of 60°.

FIG. 13 is a graph showing a ratio of a gradation value in an oblique direction to a gradation value in a front direction. The measurements are performed on a sample (III) every 10° in the range of from the front direction (a direction at a polar angle of 0°) to the direction at a polar angle of 60°.

FIG. 11 is a graph showing a ratio of a gradation value in an oblique direction to a gradation value in a front direction. The measurements are performed on a sample (IV) every 10° in the range of from the front direction (a direction at a polar angle of 0°) to the direction at a polar angle of 60°.

FIG. 15 is a graph showing the mutual relationship between floating luminance and a difference between a proportion of distribution of directors in directions at polar angles of from ±20° to ±60° and a proportion of the distribution of light emitted from the backlight unit in directions at polar angles of from ±20° to ±60°.

FIG. 16 is a cross-sectional view schematically showing a liquid crystal display device in accordance with Embodiment 4.

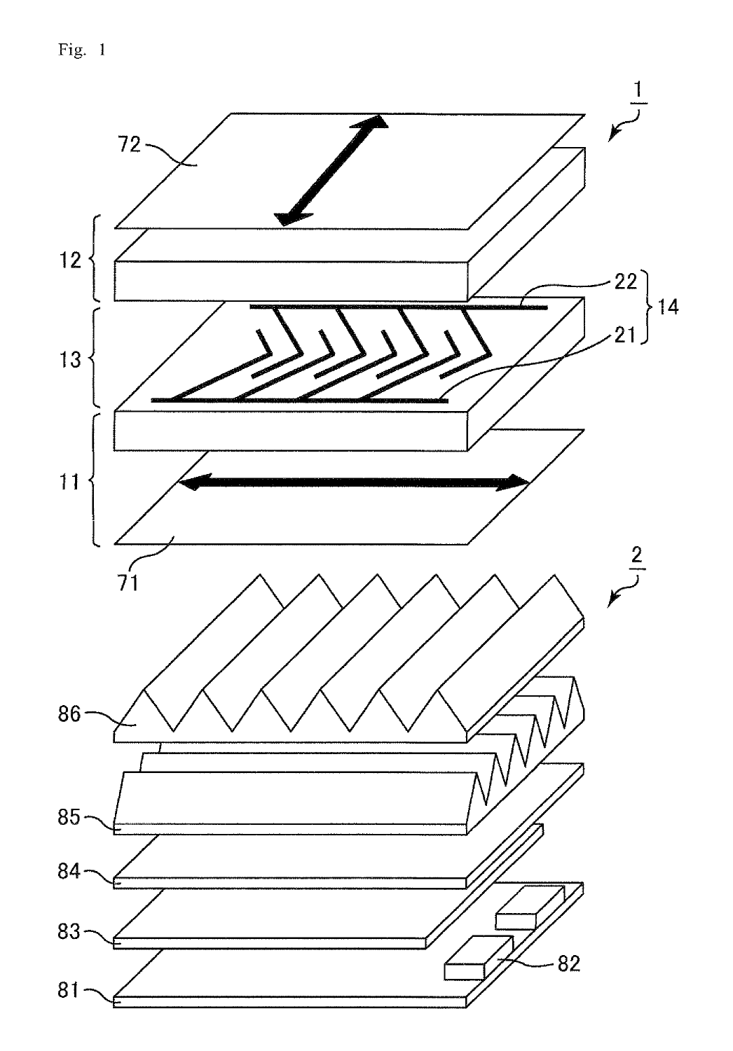

FIG. 17-1 is a conceptual view showing a state of light transmitting through a liquid crystal molecule, in which the initial inclination is vertical alignment, when no voltage is applied.

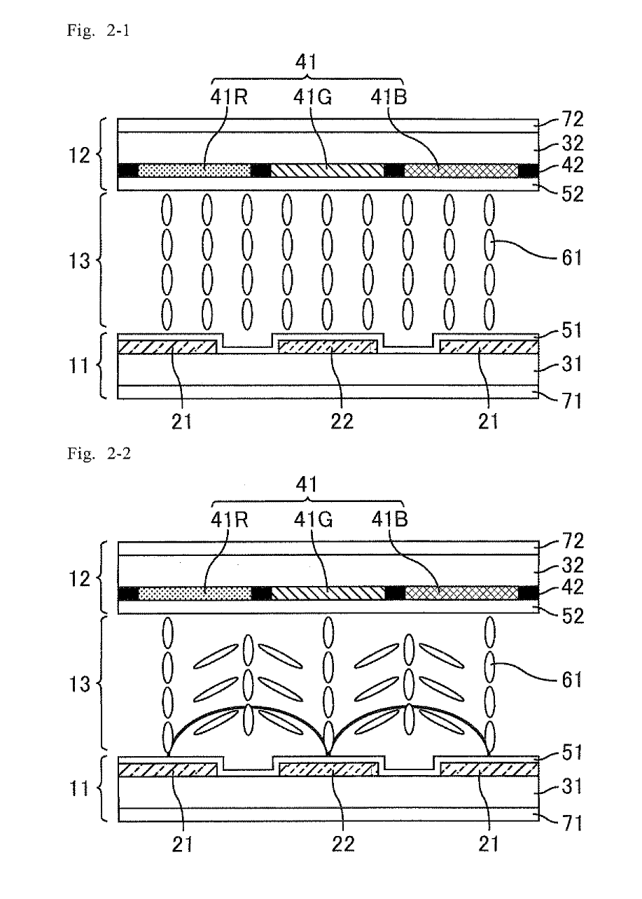

FIG. 17-2 is a conceptual view showing a state of light transmitting through a liquid crystal molecule, in which the initial inclination is vertical alignment, when an intermediate voltage is applied.

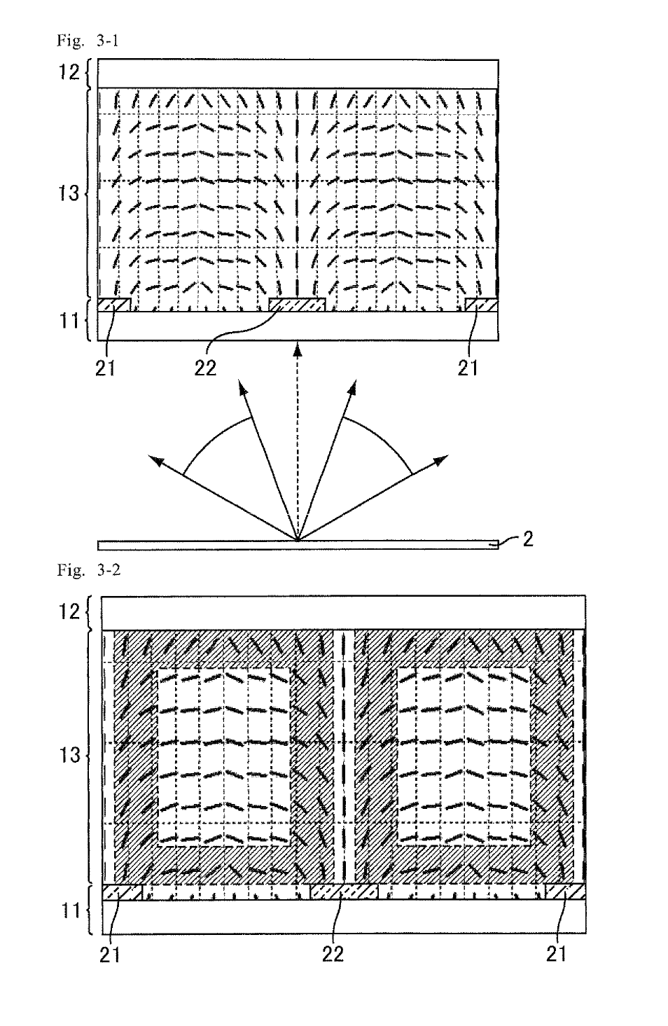

FIG. 17-3 is a conceptual view showing a state of light transmitting through a liquid crystal molecule, in which the initial inclination is vertical alignment, when a voltage is applied.

FIG. 18 is a conceptual view of a mode in which five liquid crystal molecules are oriented in different directions.

FIG. 19 is a cross-sectional view schematically showing a configuration of a liquid crystal display device in accordance with Embodiment 5.

FIG. 20 is a plan view schematically showing the configuration of the liquid crystal display device in accordance with Embodiment 5.

### MODES FOR CARRYING OUT THE INVENTION

The present invention is mentioned in more detail below with reference to Embodiments using drawings, but not limited thereto.

### Embodiment 1

FIG. 1 is a perspective view schematically showing a liquid crystal display device in accordance with Embodiment 1. The liquid crystal display device of Embodiment 1 includes a liquid crystal display panel 1 having a liquid crystal layer 13 and a pair of substrates 11 and 12 sandwiching the liquid crystal layer 13. Specifically, the TFT substrate 11, the liquid crystal layer 13, and the counter substrate 12 are disposed in this order from a back face side toward a observation face side of the liquid crystal display device of Embodiment 1. The liquid crystal layer 13 includes nematic liquid crystal with positive dielectric anisotropy (Δ∈>0). The liquid crystal display device of Embodiment 1 includes a backlight unit 2 disposed on the back face side of the liquid crystal display panel 1.

As shown in FIG. 1, the TFT substrate 11 of the pair of substrates has a pair of comb-shaped electrodes 14 in which comb teeth of one of the pair of comb-shaped electrodes and comb teeth of the other of the pair of comb-shaped electrodes 14 are alternately disposed and spaced apart from each other. The one of the pair of comb-shaped electrodes 14 is a pixel electrode 21 to which a signal voltage is applied through signal lines (source lines), and the other is a counter electrode 22 to which a common voltage is applied through common lines. Each of the pixel electrode 21 and the counter electrode 22 includes a handle portion as a trunk and comb teeth protruded from the handle portion as essential components. The comb teeth of the pair of comb-shaped electrodes 14 each have a V shape when the TFT substrate 11 is viewed in a vertical direction. Each of the comb teeth has such a shape in order to adjust the alignment direction of liquid crystal molecules to an angle of 45° relative to transmission axes of polarizers 71 and 72 mentioned below, and in order to fit the below-mentioned two lens sheets that are arranged in a cross. Each of the comb teeth may have a linear shape, and may have another shape, as long as a desired electric field (for example, transverse electric field) can be generated by the pair of comb-shaped electrodes 14. Preferred examples of the materials used in the pixel electrode 21 and the counter electrode 22 include metal oxides such as indium tin oxide (ITO) with translucency.

The pixel electrode 21 is connected with a thin film transistor (TFT) including a semiconductor layer, and further connected with a source line via the TFT. The TFT is connected with a gate line, and a gate voltage is applied to the semiconductor layer via the gate line. At the same time, the source line and the pixel electrode 21 are electrically connected with each other, and the signal voltage is applied to the pixel electrode 21.

The counter electrode 22 is connected with the common line that are located at an area overlapping with the gate line and source line. An insulating film is disposed between the common line, and the gate line and source line. The gate line and the source line are arranged perpendicular to each other. A region surrounded with two gate lines and two source lines, that is, a region surrounded with the common lines forms one sub pixel. One color filter is arranged to correspond one sub pixel, and a plurality of sub pixels form one pixel.

FIGS. 2-1 and 2-2 are cross-sectional views schematically showing the liquid crystal display device in accordance with Embodiment 1, and particularly showing behavior of liquid crystal molecules in detail. FIG. 2-1 shows a state of a liquid crystal layer to which no voltage is applied. FIG. 2-2 shows a state of a liquid crystal layer to which a voltage is applied.

The TFT substrate 11 has a glass substrate 31, and the pixel electrode 21 and the counter electrode 22 disposed on the liquid crystal layer 13-side surface of the glass substrate 31. The pixel electrode 21 and the counter electrode 22 are alternately arranged in a transverse direction when viewed in a cross section.

The counter substrate 12 includes a glass substrate 32 and a color filter 41. The color filter 41 is arranged on the liquid-crystal-layer-13-side surface of the glass substrate 32. The color filter 41 is composed of at least one of a red color filter 41R, a green color filter 41G, and a blue color filter 41B. One color filter corresponds to one sub pixel. Combination of red, green, and blue sub pixels forms one pixel. The color filter 41 may include colors other than these colors. A black-colored black matrix (BM) 42 is arranged between the adjacent two color filters having colors different from each other to prevent color mixing and light leakage.

Vertical alignment films 51 and 52 are arranged on surfaces of the TFT substrate 11 and the counter substrate 12, respectively. The surfaces are in contact with the liquid crystal layer 13. As shown in FIG. 2-1, liquid crystal molecules 61 have homeotropic alignment, that is, alignment perpendicular to the surfaces of the pair of substrates 11 and 12, when no voltage is applied. Specifically, longitudinal axes of the rod-shaped liquid crystal molecules 61 are oriented in a direction perpendicular to the substrate surface. The molecules 61 are oriented in the same direction and regularly arranged.

As shown in FIG. 2-2, when a voltage is applied between the pixel electrode 21 and the counter electrode 22, the liquid crystal molecules 61 are aligned along an arch-shaped transverse electric field formed between the electrodes. The liquid crystal molecules 61 are thus influenced by such an electric field, and transversely aligned as a whole to form bend alignment in which the molecules are aligned symmetrically to a middle region between the comb teeth (the pixel electrode 21 and the counter electrode 22). However, as shown in FIG. 2-2, liquid crystal molecules 61 present at an end of the arch-shaped transverse electric field, that is, liquid crystal molecules 61 present at just above the pixel electrode and the counter electrode 22 are less likely to be affected by the electric field change of the liquid crystal molecules 61. Therefore, such liquid crystal molecules 61 remain aligned in a direction perpendicular to the substrate surface. The middle region is a region farthest from the comb teeth. Therefore, liquid crystal molecules 61 present at the middle region between the comb teeth (the pixel electrode 21 and the counter electrode 22) also remain aligned in a direction perpendicular to the pair of substrates 11 and 12.

The TFT substrate 11 and the counter substrate 12 have polarizers 71 and 72, respectively. The polarizer 71 is arranged in the outermost portion of the back face side of the TFT substrate 11. The polarizer 72 is arranged in the outermost portion of the observation face side of the counter substrate 12. The polarizers 71 and 72 are allowed to transmit only polarized light vibrating in a certain direction (a transmission axis direction) of natural light emitted from a light source. The arrows in the polarizers 71 and 72 shown in FIG. 1 show the respective polarized light axis directions of the polarizers. The transmission axis directions of the polarizers 71 and 72 are each adjusted to make an angle of 45° with a comb-tooth-extending direction.

According to Embodiment 1, the liquid crystal molecules 61 are aligned in a direction perpendicular to the substrates 11 and 12 when no voltage is applied. Therefore, the transmission axis of the polarizer 71 of the TFT substrate 11 intersects with the transmission axis of the polarizer 72 of the counter substrate 12 (they are in a cross-Nicol state). Accordingly, light transmitting through the liquid crystal layer 13 when no voltage is applied is blocked with the polarizers 71 and 72. As mentioned above, the liquid crystal molecules 61 have a vertical alignment as the initial alignment, and the polarizers 71 and 72 are in a cross-Nicol state, which provide a normally black display mode with a high contrast ratio.

Meanwhile, in the case where above a certain voltage is applied, the liquid crystal molecules 61 are aligned along a transverse electric field, and at this time a vibrating direction (polarized light axis) of light transmitted through the liquid crystal layer 12 is changed. So, the light transmitted through the liquid crystal layer 12 can pass through the polarizer 72 on the counter substrate 12 side. As a result, the light passes through the liquid crystal display panel 1 and is used as display light.

The configuration of the backlight unit 2 in Embodiment 1 is described in detail below. The backlight unit 2 includes a reflective sheet 81, a light source 82, a light guide plate 83, a diffusion sheet 84, a first lens sheet 85, and a second lens sheet 86. Among such members, the reflective sheet 81 is arranged in the outermost portion of the back face side, and the light guide plate 83 is arranged on the reflective sheet 81 (observation face side of the reflective sheet). The light source 82 is arranged beside the light guide plate 83, and the diffusion sheet 84 is arranged on the light guide plate 83. The light source 82 emits light to the light guide plate 83. Further, the first lens sheet 85 and the second lens sheet 86 are stacked on the diffusion sheet 84. Such a configuration of the backlight unit of Embodiment 1 is of an edge light type.

The reflective sheet 81 is a member arranged for improvement of utilization efficiency of light emitted from the light source 82, and covers the entire bottom face of the backlight unit 2. Examples of a material of the reflective sheet 81 include polyethylene terephthalate (PET), a multilayer structure of a polyester resin, and a mixture of a polyester resin and an urethane resin.

The light source 82 is a member which emits light used for display in the liquid crystal display device. Examples of the light source 82 include a cold cathode fluorescent tube (CCFT), a light-emitting diode (LED), and an organic electro-luminescence (OEL). When used as the light source 82, the multiple LEDs are arranged along a side face of the light guide plate.

The light guide plate 83 is a transparent and colorless plate comprising an acrylic resin and polycarbonate (PC) which guides light entering the light guide plate 83 to a display face. In Embodiment 1, light emitted from the light source 82 once enters the light guide plate 83 from the side face thereof, and the incident light is reflected, refracted, and diffused with a structure pattern formed in the light guide plate 83, and emitted as planar light from a main face side of the light guide plate 83 toward the liquid crystal display panel 1.

The diffusion sheet 84 is an optical sheet that diffuses the outgoing light emitted from the light guide plate 83 to widen a viewing angle of display. Examples of the diffusion sheet 84 include a sheet diffusing light using surface roughness thereof due to a sheet material, and a sheet on which beads are dispersed in a binder. Examples of a material of the diffusion sheet 85 include PET, PC, and PMMA (polymethyl methacryl acid).

The first lens sheet 85 and the second lens sheet 86 both are prism sheets, and are served as optical sheets condensing, in a front direction, diffusing light emitted from the diffusion sheet 84 to improve the luminance. The first lens sheet 85 and the second lens sheet 86 each have a surface with recessed and projecting portions, and the recessed and projecting portions constitute a plurality of folds that are parallel to each other. In Embodiment 1, folds of the first lens sheet 85 are arranged to cross folds of the second lens sheet 86. Such folds arranged to cross each other provide effects of light condensing, and provide viewing angle luminance balanced in an up-down direction and a left-right direction. That is, uniform viewing angle distribution can be achieved. Thus, the configuration of the backlight unit in Embodiment 1 is of a lens cross type. Examples of a material of the first lens sheet 85 and second lens sheet 86 include polyesters and acrylic resins, specifically a BEF lens (product of Sumitomo 3M Limited). The angle of the prism of the BEF lens is 90°.

During white display, in the liquid crystal display device of Embodiment 1, the liquid crystal molecules are classified into three groups, specifically, liquid crystal molecules aligned perpendicularly to the pair of substrates 11 and 12, liquid crystal molecules aligned transversely thereto, and liquid crystal molecules aligned obliquely thereto. The orientation of the liquid crystal molecules aligned obliquely thereto is determined depending on the positional relationship with the comb-shaped electrode. Such liquid crystal molecules in a rod shape are aligned so that one of the ends of each of the liquid crystal molecules is oriented toward the nearest comb-shaped electrode.

As shown in FIGS. 2-1 and 2-2, when the pair of substrates 11 and 12 are viewed in the cross section, the liquid crystal molecules obliquely aligned are classified into liquid crystal molecules aligned obliquely from bottom left to top right, and liquid crystal molecules aligned obliquely from top left to bottom right. Accordingly, in a state where a voltage is applied, the liquid crystal molecules exhibit alignment such that the molecules are tilted in any of directions at angles of from 0° to ±90° symmetrically to the each of the comb teeth (lines) of the comb-shaped electrode. Further, the molecules are regularly distributed symmetrically to a region above the electrode and a middle region of a region between the electrodes. Therefore, director distribution in Embodiment 1 is symmetrical to a polar angle of 0° to form regular distribution. The term “polar angle” used herein refers to the following. The direction perpendicular to the pair of substrates 11 and 12 is defined as a direction at a polar angle of 0° when the pair of substrates 11 and 12 are viewed in the cross section. A positive polar angle is defined as an angle between the direction at a polar angle of 0° and a right oblique direction, and a negative polar angle is defined as an angle between the direction at a polar angle of 0° and a left oblique direction.

According to Embodiment 1, a proportion of light in directions at polar angles of from ±20° to ±60° in distribution of light emitted from the backlight unit 2 and a proportion of directors in directions at polar angles of from ±20° to ±60° in director distribution of liquid crystal molecules are adjusted to be close to each other. FIGS. 3-1 and 3-2 are cross-sectional views schematically showing the liquid crystal display device in accordance with Embodiment 1. FIG. 3-1 shows director distribution during white display, and particularly shows the entire director distribution. FIG. 3-2 shows distribution of light emitted from a backlight unit, and particularly shows director distribution in directions at polar angles of from ±20° to ±60°.

As shown in FIGS. 3-1 and 3-2, liquid crystal molecules included in the liquid crystal layer 13 that is sandwiched between the pair of substrates 11 and 12 are affected by an electric field formed between the pair of comb-shaped electrodes 21 and 22. Therefore, the liquid crystal molecules are vertically aligned in a region above the comb-shaped electrodes, and are transversely aligned in a bent shape in a region between the comb-shaped electrodes. In the liquid crystal layer 13, director distribution is regularly and symmetrically formed by the alignment of the liquid crystal molecules.

In FIG. 3-2, the hatched part shows distribution of directors in directions at polar angles of from ±20° to ±60°. In FIG. 3-1, each angle made by two solid line arrows corresponds to distribution of light emitted from a backlight unit in directions at polar angles of from ±20° to ±60°. The dashed line arrow shows a direction at a polar angle of 0°. As shown in FIG. 3-2, the directors oriented in directions at polar angles of from ±20° to ±60° are mainly distributed in the vicinity of the substrates and the vicinity of electrodes. Specifically, distribution of directors in directions at polar angles of from ±20° to ±60° in the present Embodiment forms distribution in which a region far from the pair of glass substrates 31 and 32 and the pair of comb-shaped electrodes 21 and 22 is cut out from each of a plurality of director distribution blocks separated by a region including vertically aligned liquid crystal molecules above an electrode.

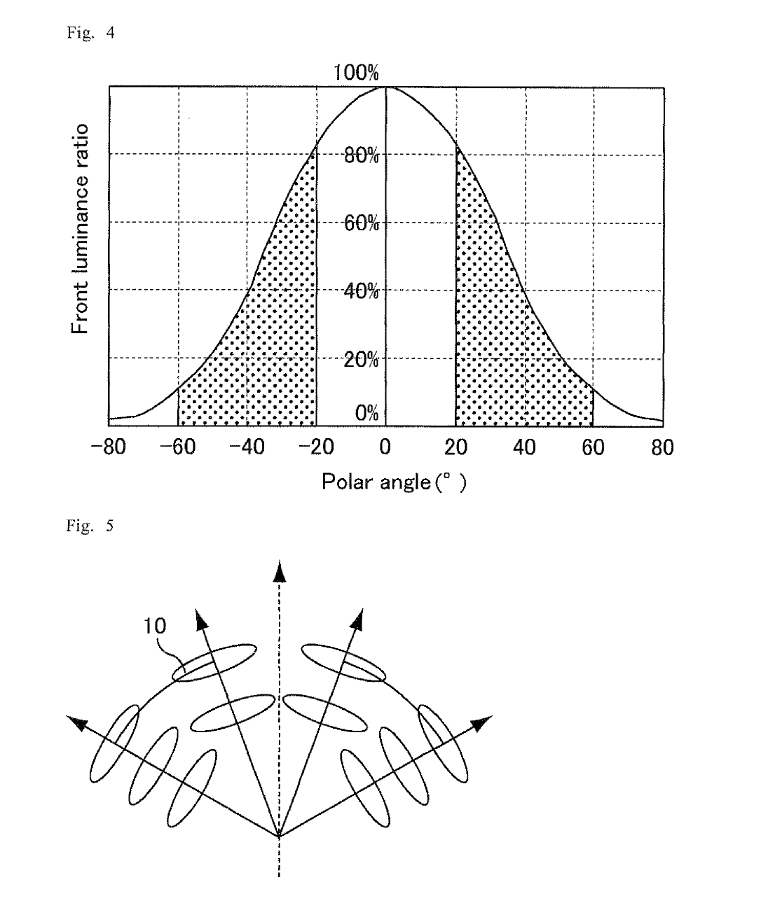

FIG. 4 is a graph showing distribution of light emitted from the backlight unit included in the liquid crystal display device in accordance with Embodiment 1. The distribution is represented by the relationship between a polar angle and luminance. The graph shown in FIG. 4 shows the results obtained by actually measuring an edge light (lens cross type) backlight unit using a two-dimensional fourier transform type optical goniometer (EZ-CONTRAST, product of ELDIM). In FIG. 4, the vertical axis represents a luminance ratio when luminance in the front direction (polar angle of 0°) is taken as 100%. The horizontal axis represents a polar angle. As shown in FIG. 4, the distribution of light emitted from the backlight unit in Embodiment 1 shows that luminance is gently decreased as a polar angle is decreased or increased from a polar angle of 0° as the center of luminance. According to the above-mentioned measurement results, (i) the proportion of the distribution of light emitted from a backlight unit in directions at polar angles of from 0° to ±20° is 50%, (ii) the proportion of the distribution of light emitted from a backlight unit in directions at polar angles of from ±20° to ±60° is 47%, and (iii) the proportion of the distribution of light emitted from a backlight unit in directions at polar angles of from ±60° to ±90° is 3%.

FIG. 5 is a conceptual view created by overlaying the distribution of directors in directions at polar angles of from ±20° to ±50° and the distribution of light emitted from a backlight unit in directions at polar angles of from ±20° to ±60°. As shown in FIG. 5, in the overlapping portions of the distribution of directors in directions at polar angles of from ±20° to ±60° and the distribution of light emitted from a backlight unit in directions at polar angles of from ±20° to ±60°, the traveling direction of light is substantially perpendicular to the longitudinal directions of the liquid crystal molecules 10. Therefore, light in the range of polar angles of from ±20° to ±60° can transmit the liquid crystal molecules 10 with high transmittance. In the liquid crystal display device having the present mode providing a wide viewing angle, the improved effect of the particularly excellent display qualities can be achieved by particularly increasing the transmittance in a region of the emitted light distribution of light in directions at polar angles of from ±20° to ±60°.

According to the present Embodiment, a difference between the proportion of distribution of directors in a range of a polar angle from ±20° to ±60° and the proportion of distribution of light emitted from a backlight unit in a range of a polar angle from ±20° to ±60° is adjusted to less than 20%. The director distribution can be adjusted depending on the width of each of the comb teeth of a comb-shaped electrode, the distance between the adjacent two comb teeth, the dielectric anisotropy (Δ∈) of liquid crystal molecules, and the like. The proportion of the director distribution can be determined (calculated) using a nuclear magnetic resonance (NMR) analysis and the like. The distribution of light emitted from a backlight unit can be adjusted depending on an angle and an orientation of the inclination face of the recessed and projecting portions of the lens sheet, the number of the sheets, a material of the sheets. The distribution of light emitted from a backlight unit can be determined (calculated) using a two-dimensional fourier transform type optical goniometer.

### Embodiment 2

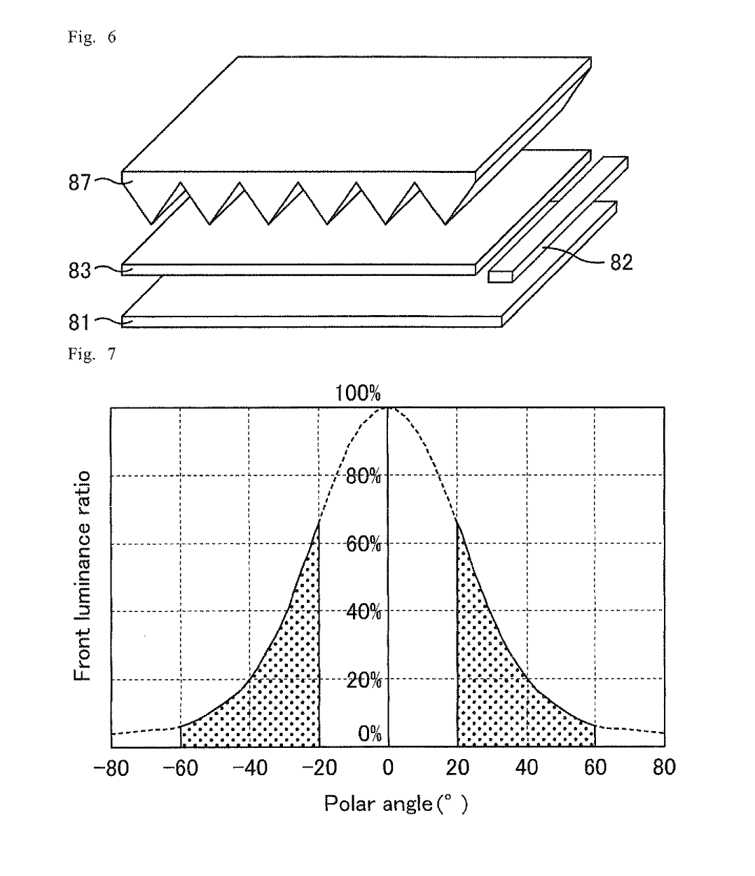

FIG. 6 is a cross-sectional view schematically showing a backlight unit included in a liquid crystal display device in accordance with Embodiment 2. The liquid crystal display device of Embodiment 2 has the same configuration as that of the liquid crystal display device of Embodiment 1 except for the configuration of the backlight unit. As shown in FIG. 6, the backlight unit included in the liquid crystal display device of Embodiment 2 includes a reflective sheet 81, a light source 82, a light guide plate 83, and a third lens sheet 87. Among such members, the reflective sheet 81 is arranged at the outermost portion of the back face side, and the light guide plate 83 is arranged on the reflective sheet 81 (observation face side of the reflective sheet). The light source 82 is arranged beside the light guide plate 83 so that the light source 82 emits light to the light guide plate 83, and a third lens sheet 87 is arranged on the light guide plate 83 so that the surface of the recessed and projecting portions of the third lens sheet 87 faces the light guide plate 83. Such a configuration of the backlight unit of Embodiment 2 is of an edge light type.

The third lens sheet 87 included in the liquid crystal display device of Embodiment 2 is a reverse prism sheet (for example, DIAART, product of MITSUBISHI RAYON CO., LTD.), and the reverse prism sheet has a downward prism angle of 63°. In such a case, the upper surface of the third lens sheet 87 functions as a diffuser. According to such a configuration, the backlight unit may be composed of a small number of members. Such a configuration of the backlight unit of Embodiment 2 is of a reverse prism type.

FIG. 7 is a graph showing distribution of light emitted from the backlight unit included in the liquid crystal display device in accordance with Embodiment 2. The distribution is represented by the relationship between a polar angle and luminance. The graph shown in FIG. 7 shows the results obtained by actually measuring the reverse prism backlight unit using a two-dimensional fourier transform type optical goniometer (EZ-CONTRAST, product of ELDIM). In FIG. 7, the vertical axis represents a luminance ratio when luminance in the front direction (polar angle of 0°) is taken as 100%. The horizontal axis represents a polar angle. As shown in FIG. 7, the distribution of light emitted from the backlight unit in Embodiment 2 shows that luminance is gradually decreased from the luminance at a polar angle of 0°, as a polar angle is shifted from 0° to ±90°. According to the above-mentioned measurement results, (i) the proportion of the distribution of light emitted from a backlight unit in directions at polar angles of from 0° to ±20° was 56%, (ii) the proportion of the distribution of light emitted from a backlight unit in directions at polar angles of from ±20° to ±60° was 40%, and (iii) the proportion of the distribution of light emitted from a backlight unit in directions at polar angles of from ±60° to ±90° was 4%.

In the case where such a reverse prism backlight unit (Embodiment 2) is used, the slope of the curve of decrease in luminance is made steeper when the polar angle is shifted from 0° to ±90° as compared to the case where the lens cross type backlight unit (Embodiment 1) composed of two BEF lens sheets stacked is used. Accordingly, according to Embodiment 2, the proportion of the distribution of light emitted from a backlight unit in directions at polar angles of from ±20° to ±60° can be reduced.

### Embodiment 3

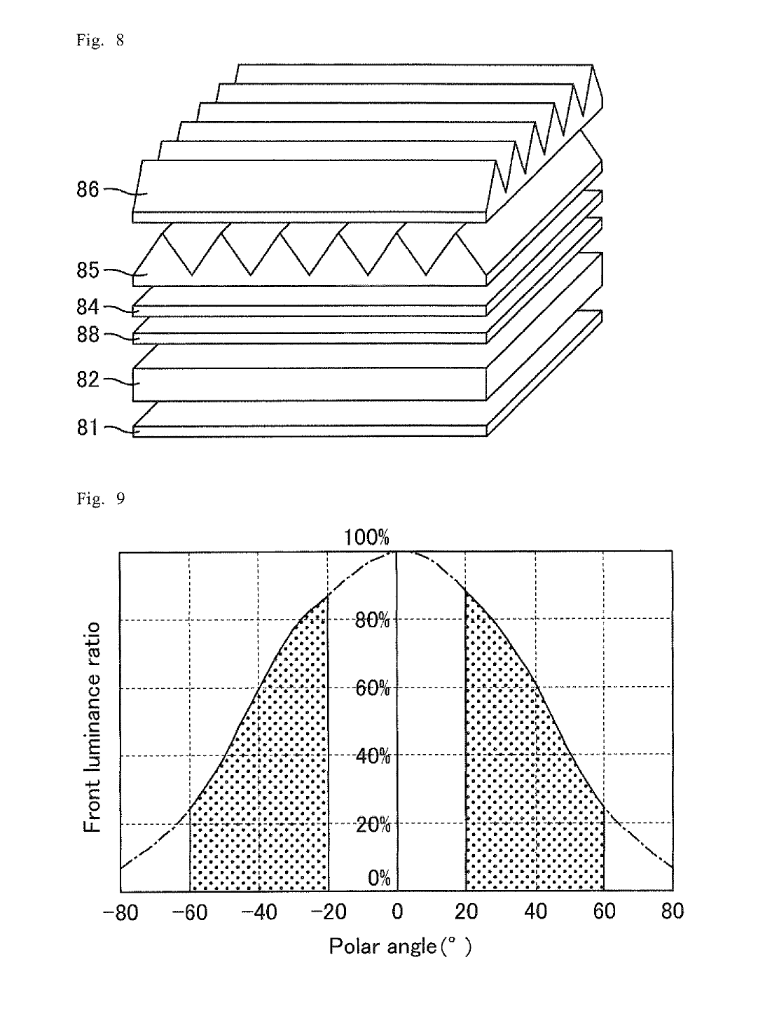

FIG. 8 is a cross-sectional view schematically showing a backlight unit included in a liquid crystal display device in accordance with Embodiment 3. The liquid crystal display device of Embodiment 3 has the same configuration as that of the liquid crystal display device of Embodiment 1 except for the configuration of the backlight unit. As shown in FIG. 8, the backlight unit included in the liquid crystal display device of Embodiment 3 includes a reflective sheet 81, a light source 82, a diffuser 88, a diffusion sheet 84, a first lens sheet 85, and a second lens sheet 86. Among such members, the reflective sheet 81 is arranged in the outermost portion of the back face side, and the light source 82 is arranged on the reflective sheet 81 (observation face side of the reflective sheet). The diffuser 88, the diffusion sheet 84, the first lens sheet 85, and the second lens sheet 86 are arranged above the light source 82 in this order. Like the diffusion sheet 84, the diffuser 88 diffuses light entering the diffuser, which widens a viewing angle of display.

According to such a direct backlight unit, light emitted from the light source is allowed to linearly enter a panel, and a sufficient quantity of light can be secured. Therefore, such a direct backlight unit is particularly suitably used for a large-sized display device.

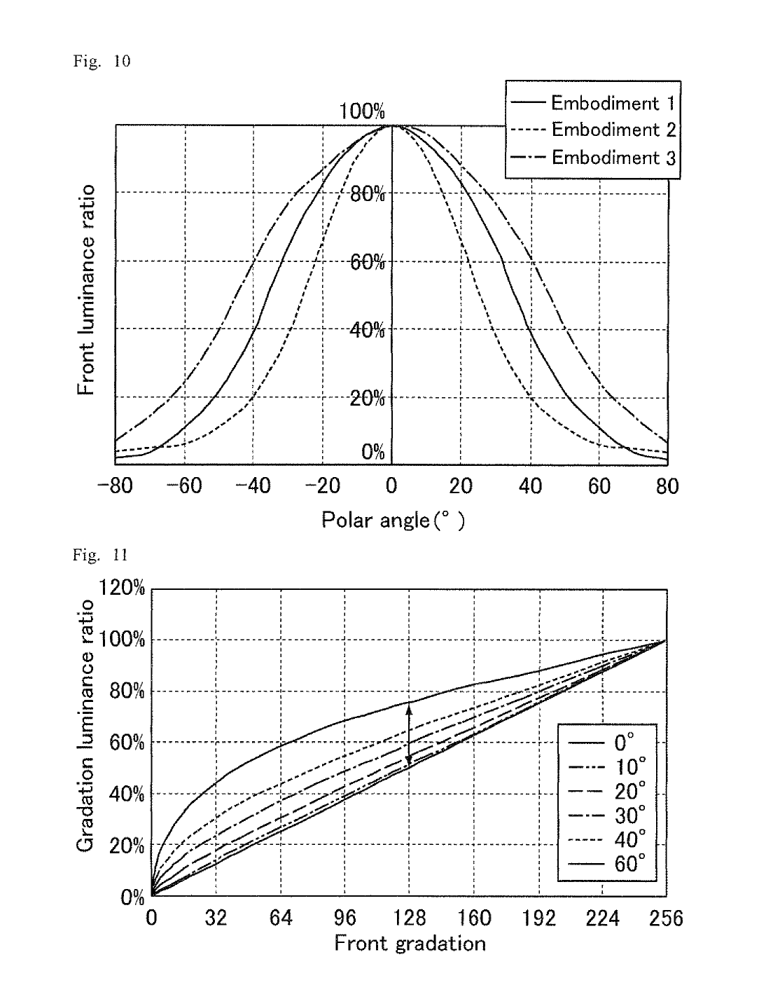

FIG. 9 is a graph showing distribution of light emitted from the backlight unit included in the liquid crystal display device in accordance with Embodiment 3. The distribution is represented by the relationship between a polar angle and luminance. The graph shown in FIG. 9 shows the results obtained by actually measuring the direct backlight unit using a two-dimensional Fourier transform type optical goniometer (EZ-CONTRAST, product of ELDIM). In FIG. 9, the vertical axis represents a luminance ratio when luminance in the front direction (polar angle of 0°) is taken as 100%. The horizontal axis represents a polar angle. As shown in FIG. 9, the distribution of light emitted from the backlight unit in Embodiment 3 shows that luminance is gradually decreased from the luminance at a polar angle of 0°, as a polar angle is shifted from 0° to ±90°. According to the above-mentioned measurement results, (i) the proportion of the distribution of light emitted from a backlight unit in directions at polar angles of from 0° to ±20° was 42%, (ii) the proportion of the distribution of light emitted from a backlight unit in directions at polar angles of from ±20° to ±60° was 51%, and (iii) the proportion of the distribution of light emitted from a backlight unit in directions at polar angles of from ±60° to ±90° was 7%.

In the case where the direct (lens cross type) backlight unit (Embodiment 3) is used, the slope of the curve of decrease in luminance is made gentle when a polar angle is shifted from 0° to ±90° as compared to the case of the edge light (lens cross type) backlight unit (Embodiment 1). Accordingly, according to Embodiment 3, the proportion of the distribution of light emitted from the backlight unit in directions at polar angles of from ±20° to ±60° can be further increased.

FIG. 10 is shown as reference. FIG. 10 is a graph containing curves of the distribution of light emitted from the backlight units included in the respective liquid crystal display devices in accordance with Embodiments 1 to 3. The distribution is represented by the relationship between a polar angle and luminance ratio. Table 1 shows data on the distribution of light emitted from the backlight units, in each polar angle, included in the respective liquid crystal display devices in accordance with Embodiments 1 to 3.

TABLE 1

| | Proportion of light flux (relative to all emitted light) | | |
|---|---|---|---|
| Distribution | Embodiment 1 | Embodiment 2 | Embodiment 3 |
| angle | Edge light backlight unit | | Direct backlight unit |
| (polar angle) | Lens cross type | Reverse prism type | Lens cross type |
| 0° < ±20° | 50% | 56% | 42% |
| ±20° ≦ ±60° | 47% | 40% | 51% |
| ±60° < 90° | 3% | 4% | 7% |

### Evaluation Test 1

The following shows the evaluation results of a plurality of examples of the director distribution and the backlight unit emitted light distribution, which were set under different conditions based on the configurations of the liquid crystal display devices of Embodiments 1 to 3. In the evaluation test 1, a general drive system is used as a drive method of a liquid crystal display device.

First, a line width (L) of each of comb teeth and a space (S) between the adjacent two comb teeth were set under different conditions using an LCD-MASTER produced by Shintex Japan Corp., and proportions of distribution of directors at every distribution angle (polar angle) were determined. Table 2 shows the simulation results of the director distribution, represented by the relationship between the line width (L) of each of the comb teeth and the space between the adjacent two comb teeth (S). The simulations were examined on liquid crystal molecules with dielectric anisotropy Δ∈ of 14, liquid crystal molecules with dielectric anisotropy Δ∈ of 15, and liquid crystal molecules with dielectric anisotropy Δ∈ of 23. Examination Examples 1 to 10 were regarded as combinations of the line width L of each of the comb teeth and the space S between the adjacent two the comb teeth.

TABLE 2

| | | Exam- | Exam- | Exam- | Exam- | Exam- | Exam- | Exam- | | | |
|---|---|---|---|---|---|---|---|---|---|---|---|
| | | ination | ination | ination | ination | ination | ination | ination | Examination | Examination | Examination |
| | | Example 1 | Example 2 | Example 3 | Example 4 | Example 5 | Example 6 | Example 7 | Example 8 | Example 9 | Example 10 |
| | L (μm) | 3 | 3 | 3 | 3 | 3 | 4 | 4 | 4 | 4 | 4 |
| | S (μm) | 2 | 3 | 6 | 8 | 12 | 3 | 4 | 6 | 8 | 12 |
| Δε = 14 | 0° < ±20° | 38.1% | 33.9% | 30.2% | 29.8% | 59.1% | | | | | |
| | ±20° ≦ ±60° | 50.8% | 45.0% | 43.1% | 42.8% | 30.9% | | | | | |
| | ±60° < 90° | 11.1% | 21.1% | 26.7% | 27.4% | 10.0% | | | | | |
| Δε = 15 | 0° < ±20° | 37.2% | 34.7% | 29.3% | 28.6% | 31.4% | 33.0% | 32.3% | 31.1% | 30.7% | 32.2% |
| | ±20° ≦ ±60° | 50.2% | 46.1% | 43.2% | 39.0% | 43.0% | 41.7% | 40.6% | 40.8% | 35.7% | 40.6% |
| | ±60° < 90° | 12.6% | 19.3% | 27.4% | 32.5% | 25.6% | 25.3% | 27.1% | 28.1% | 33.6% | 27.2% |
| Δε = 23 | 0° < ±20° | 32.9% | 29.2% | 24.9% | 23.2% | 24.8% | 29.3% | 27.4% | 26.3% | 26.0% | 26.0% |
| | ±20° ≦ ±60° | 46.5% | 39.9% | 36.9% | 31.8% | 33.8% | 38.2% | 36.2% | 35.9% | 30.1% | 32.1% |
| | ±60° < 90° | 20.6% | 31.0% | 38.3% | 44.9% | 41.4% | 32.5% | 36.4% | 37.7% | 43.8% | 41.9% |

Then, a plurality of pairs of glass substrates was prepared, and samples were prepared by the following steps. An ITO film was formed on the entire surface of one of each pair of glass substrates; and a pair of comb-shaped electrodes made of ITO was prepared by photolithography so that the width (electrode width) L of a line 91 of each of the comb teeth and the width (electrode space) S of a space 92 between the adjacent two comb teeth corresponded to those shown in Table 2.

Then, an alignment film coating material JALS-204 (5 wt %, γ-butyrolactone solution) produced by JSR was coated on the comb-shaped electrode and the glass substrate by spin coating, and baked at 200° C. for 2 hours.

The thickness of the alignment film was 1000 Å. An alignment film is formed on the other glass substrate in the same way. The alignment film exhibited strong anchoring. The anchoring strength was 0.8×10⁻⁴ J/m².

Then, 3.25-micron resin beads (Micropearl SP20325) prepared by Sekisui Chemical Co., Ltd. were dispersed on one of the thus-produced pair of substrates. A seal resin prepared by Mitsui Toatsu Chemicals, Inc. (Struct Bond XN-21S) was printed on the other substrate. The pair of substrates were then bonded, and baked at 135° C. for 1 hour to provide a liquid crystal cell.

Then, a liquid crystal material was sealed in the liquid crystal cell (between the pair of substrates) by vacuum injection, and surfaces of the pair of substrates of the liquid crystal cell are each provided with a polarizer. The surfaces were on the opposite side of surfaces facing a liquid crystal layer. Through such processes, a liquid crystal display panel A including a liquid crystal material A prepared by Merck & Co., Ltd. (Δ∈=14, Δn=0.098), a liquid crystal display panel B including a liquid crystal material B prepared by Merck & Co., Ltd. (Δ∈=15, Δn=0.098), and a liquid crystal display panel C including a liquid crystal material C prepared by Merck & Co., Ltd. (Δ∈=23, Δn=0.099) were produced. Samples of each of the liquid crystal display panels A, B, and C are produced so as to satisfy conditions of Examination Examples 1 to 10, in which the line width L of each of the comb teeth and the space S between the adjacent two comb teeth were different.

Then, thus-produced liquid crystal display panels A, B, and C were combined with each of three different backlight units produced in accordance with the respective Embodiments 1 to 3 to produce nine liquid crystal display devices A-1, A-2, A-3, B-1, B-2, B-3, C-1, C-2, and C-3.

In the liquid crystal display devices A-1, A-2, A-3, B-1, B-2, 3-3, C-1, C-2, and C-3, a gap between the uppermost surface of the backlight unit and the lowermost surface of the liquid crystal display panel was an air layer with a width of 0.1 to 0.2 mm.

The following calculation was performed on the thus-produced liquid crystal display devices A-1, A-2, A-3, B-1, B-2, B-3, C-1, C-2, and C-3. The difference (deviation) between a proportion of distribution of directors at polar angles of from ±20° to ±60° in the entire director distribution, and a proportion of distribution of light emitted from a backlight unit at polar angles of from ±20° to ±60° in the entire distribution of light emitted from a backlight unit was calculated. Table 3 summarizes deviations calculated in this way.

TABLE 3

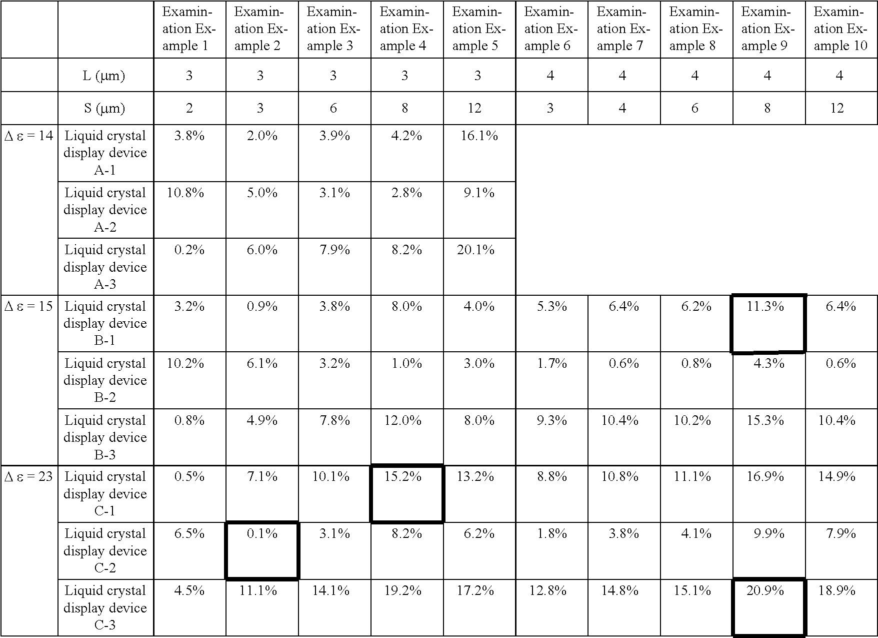

Then, a voltage-transmittance change viewed from a front direction, and a voltage-transmittance change in a polar angle direction by 45° out of the polarization axis were measured with an EZ-CONTRAST produced by ELDIM, and level change of an observation angle in an oblique direction with respect to a front direction was confirmed. The present invention will be described below based on typical samples chosen.

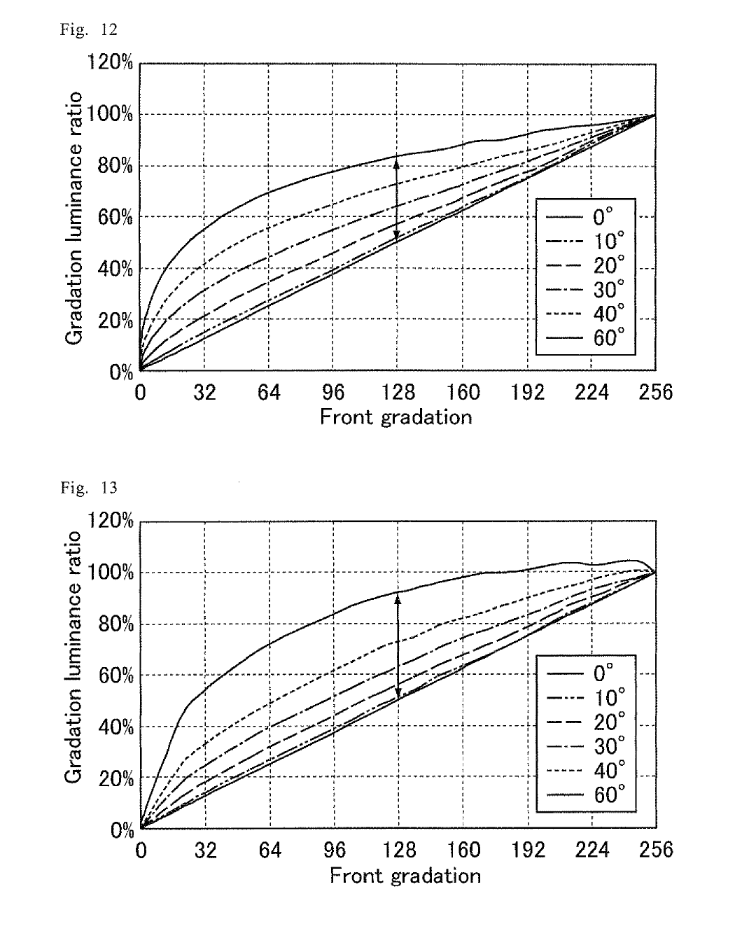

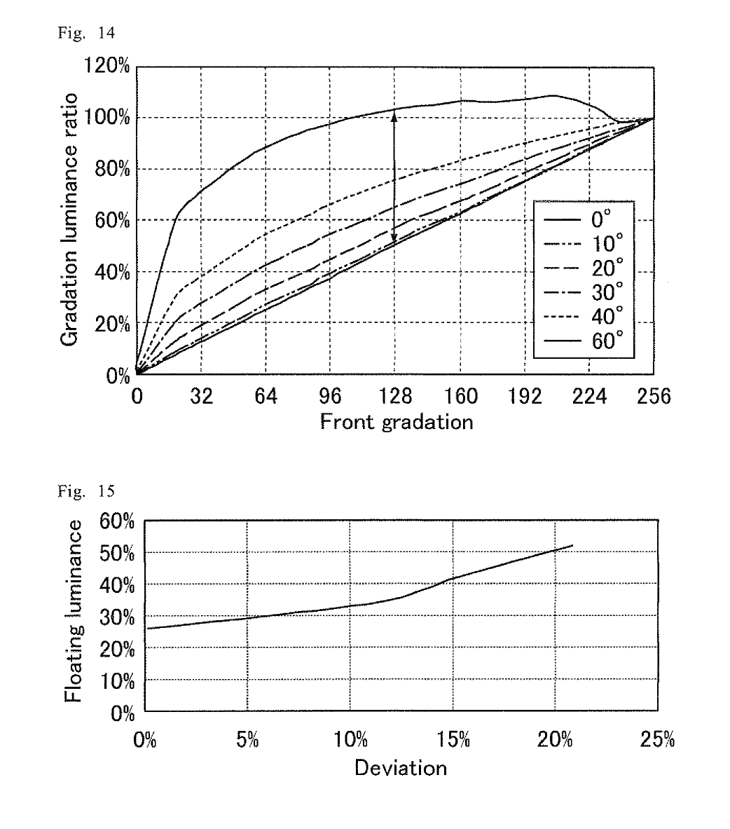

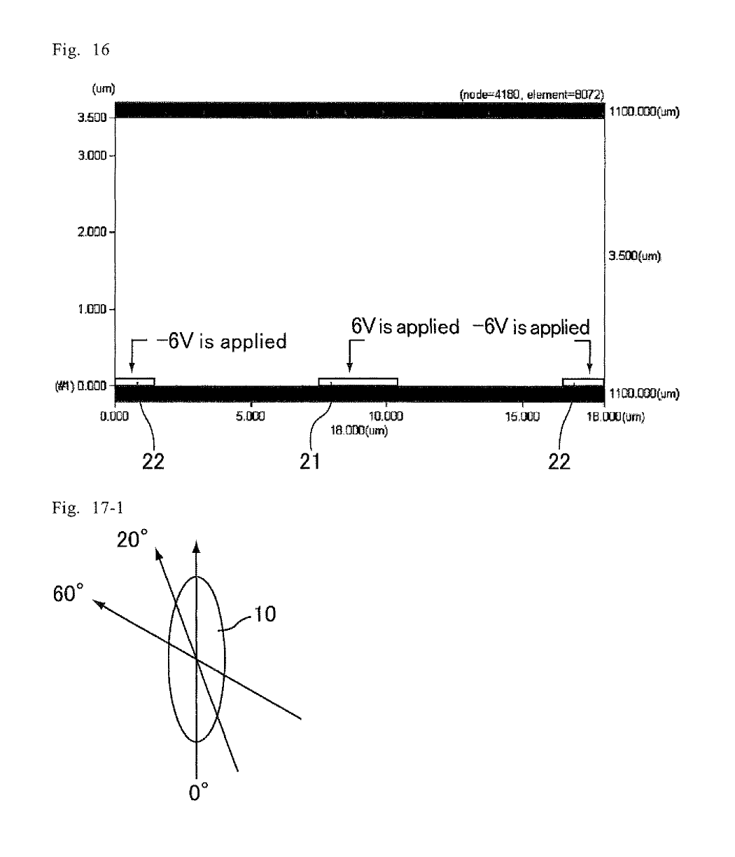

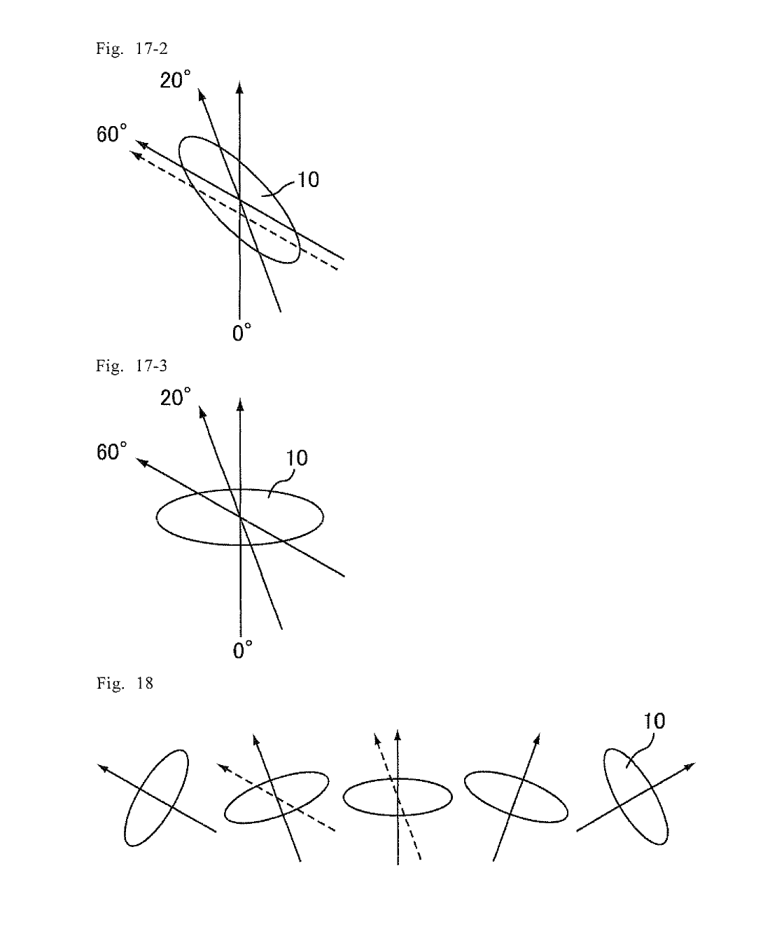

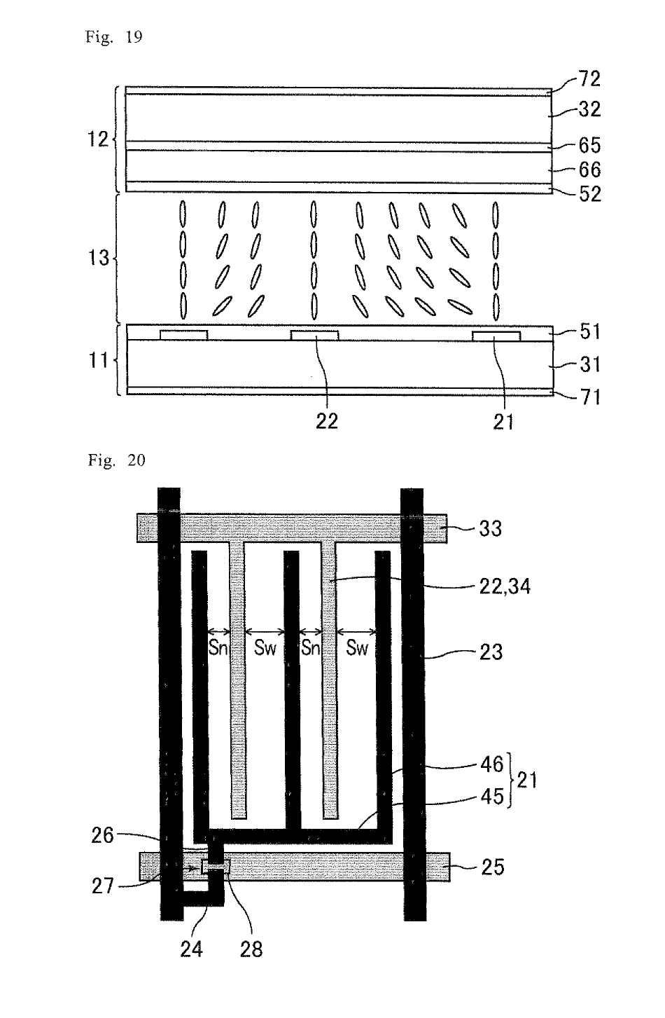

FIGS. 11 to 14 are graphs of liquid crystal display devices (bold frame in the table 3) each showing ratios of gradation values in an oblique direction to gradation values in a front direction. The ratios are shown every 10° from a front direction (a direction at a polar angle of 0°) to a direction at a polar angle of 60°. As the samples, a sample (I) of Examination Example 2 of the liquid crystal display device B-2, a sample (II) of Examination Example 9 of the liquid crystal display device A-1, a sample (III) of Examination Example 4 of the liquid crystal display device B-1, and a sample (IV) of Examination Example 9 of the liquid crystal display device B-3 were used. The sample (I) corresponds to FIG. 11, the sample (II) corresponds to FIG. 12, the sample (III) corresponds to FIG. 13, and the sample (IV) corresponds to FIG. 14.

In order to confirm the mutual relationship between a level change of an observation angle in an actual configuration, and the difference (deviation) between the proportion of the distribution of directors in directions at polar angles of from ±20° to ±60° and the proportion of the distribution of light emitted from a backlight in directions at polar angles of from ±20° to ±60°, the examination is performed under the following conditions. Specifically, based on FIGS. 11 to 14, an amount of change in each of the samples (I) to (IV) was calculated as follows. Specifically, in order to examine a change in luminance in the range of polar angles of from 0° to ±60°, that is, “floating luminance” when rotated from a front direction (a polar angle of 0°) to a direction of a polar angle of 60° in an azimuth 45° to the polarization axis, the amount of change of from a gradation luminance ratio in a front direction (polar angle of 0°) to a gradation luminance ratio in ±60° direction, when a front gradation is 128, was calculated.

According to FIG. 11, floating luminance was 26% in the sample (I). According to FIG. 12, floating luminance was 34% in the sample (II). According to FIG. 13, floating luminance was 42% in the sample (III). According to FIG. 14, floating luminance is 52% in the sample (IV). Table 4 shows the results.

TABLE 4

| | Liquid crystal | Liquid crystal | Liquid crystal | Liquid crystal |
|---|---|---|---|---|
| | display device B-2 | display device A-1 | display device B-1 | display device B-3 |
| | Examination | Examination | Examination | Examination |
| | Example 2 | Example 9 | Example 4 | Example 9 |
| Liquid crystal | Δ ε = 23 | Δ ε = 15 | Δ ε = 23 | Δ ε = 23 |
| Embodiment | 2 | 1 | 1 | 3 |
| Deviation | 0.1% | 11.3% | 15.2% | 20.9% |
| Floating luminance | 26% | 34% | 42% | 52% |
| Level based on | Excellent | Satisfactory | Acceptable | Poor |
| visual observation | | | | |

The level based on visual observation in Table 4 refers to evaluation of sense of an actual luminance change when an observation direction is changed from a front direction to an oblique direction. “Excellent” means that a change in luminance was not observed at all and superior display was provided. “Satisfactory” means that a change in luminance was hardly observed and good display was provided. “Acceptable” means that a change in luminance was slightly observed but usable display was provided. “Poor” means that a change in luminance was particularly observed and poor display was provided.

As shown in Table 4, visual observation of a viewing angle level shows that a level based on visual observation tended to drop gradually in the case where the deviation in simulation exceeds 15% and in the case where the floating luminance exceeds 40% in actual measurement. In the case where the deviation in simulation exceeds 20% and in the case where the floating luminance exceeds 50% in actual measurement, the viewing angle level dropped.

This shows that the mutual relationship was confirmed between the director distribution in simulation and the actual director distribution. When a difference between the proportion of the distribution of directors in the range of polar angles of from ±20° to ±60° in the entire director distribution, and the proportion of the distribution of light emitted from a backlight unit in the range of polar angles of from ±20° to ±60° in the entire distribution of light emitted from a backlight unit is less than 20%, a viewing angle begins to increase, and when the difference is less than 15%, the viewing angle begins to successfully increase.

Then, the mutual relationship between the change in deviation in simulation and the change in floating luminance was confirmed. FIG. 15 is a graph showing the mutual relationship between floating luminance and a difference between a proportion of distribution of directors in polar angle directions of from ±20° to ±60° and a proportion of distribution of light emitted from a backlight unit in polar angle directions of from ±20° to ±60°. As shown in FIG. 15, as the deviation between the proportion of the distribution of directors in polar angle directions of from ±20° to ±60° and the proportion of the distribution of light emitted from a backlight unit in polar angle directions of from ±20° to ±60° increased, the floating luminance increased. It was confirmed that this was in agreement with the visual observation results. According to FIG. 15, it was further confirmed that a large change in floating luminance occurred at a point where the deviation in simulation was 13%, and the rate of increase in floating luminance greatly started to change at the point as a starting point.

### Embodiment 4

The liquid crystal display device of Embodiment 4 has the same configuration as that of Embodiments 1 to 3, except that it is not driven by a single-source drive system used in Embodiments 1 to 3, in which one source line is used for one pixel, but it is driven by a double-source-polarity-inversion drive system, in which two source lines for signal supply with opposing polarities are used for one pixel,

FIG. 16 is a cross-sectional view schematically showing the liquid crystal display device in accordance with Embodiment 4. As shown in FIG. 16, a voltage of 6 V is applied to a pixel electrode 21, and a voltage of −6 V is applied to a counter electrode 22. That is, in Embodiment 4, a common voltage is not applied via a common line to the counter electrode 22, but a signal voltage is applied via another source line to the counter electrode 22. As mentioned above, the use of the two source lines for supplying the respective two signal voltages with opposing polarities and the same absolute value doubles a usual voltage applied to the liquid crystal layer. Therefore, even if a liquid crystal material with dielectric anisotropy smaller than that of a liquid crystal material used in Embodiments 1 to 3 is used, the same operation and advantages as in Embodiments 1 to 3 can be obtained.

### Evaluation Test 2

The evaluation results of the director distribution and backlight unit emitted light distribution under different conditions based on the configuration of the liquid crystal display device of Embodiment 4 are described below. The evaluation test 2 is performed in the same way as the evaluation test 1.

Table 5 shows simulation results of the director distribution represented by the relationship between the line width (L) of each of the comb teeth and the space between the adjacent two comb teeth (S). The simulations were examined on liquid crystal molecules with dielectric anisotropy Δ∈ of 2.0, liquid crystal molecules with dielectric anisotropy Δ∈ of 5.0, and liquid crystal molecules with dielectric anisotropy Δ∈ of 7.5, and liquid crystal molecules with dielectric anisotropy Δ∈ of 11.5. Examination Examples 1 to 5 were regarded as combinations of the line width L of each of the comb teeth and the space S between the adjacent two comb teeth.

TABLE 5

| | | Exam- | Exam- | Exam- | Exam- | Exam- |
|---|---|---|---|---|---|---|
| | | ination | ination | ination | ination | ination |
| | | Exam- | Exam- | Exam- | Exam- | Exam- |
| | | ple 1 | ple 2 | ple 3 | ple 4 | ple 5 |
| | L (μm) | 3 | 3 | 3 | 3 | 3 |
| | S (μm) | 2 | 3 | 6 | 8 | 12 |
| Δε = 2.0 | 0° < ±20° | 54.5% | 48.5% | 43.8% | 45.7% | 77.3% |
| | ±20° ≦ ±60° | 44.4% | 49.2% | 55.9% | 54.3% | 22.7% |
| | ±60° < 90° | 1.1% | 2.3% | 0.2% | 0.0% | 0.0% |
| Δε = 5.0 | 0° < ±20° | 38.3% | 33.7% | 28.8% | 27.4% | 28.5% |
| | ±20° ≦ ±60° | 50.1% | 45.1% | 40.5% | 39.6% | 42.8% |
| | ±60° < 90° | 11.6% | 21.2% | 30.8% | 32.9% | 28.8% |
| Δε = 7.5 | 0° < ±20° | 34.4% | 30.4% | 24.1% | 22.8% | 23.7% |
| | ±20° ≦ ±60° | 46.4% | 40.4% | 35.0% | 33.4% | 34.2% |
| | ±60° < 90° | 19.2% | 29.3% | 40.9% | 43.8% | 42.1% |
| Δε = 11.5 | 0° < ±20° | 31.2% | 27.1% | 21.5% | 20.1% | 18.2% |
| | ±20° ≦ ±60° | 43.8% | 38.2% | 31.2% | 30.0% | 29.4% |
| | ±60° < 90° | 24.9% | 34.7% | 47.3% | 49.9% | 52.5% |

Liquid crystal display panels D, E, F, and G were produced using a liquid crystal material D prepared by Merck & Co., Ltd. (Δ∈=2.0, Δn=0.098), a liquid crystal material E prepared by Merck & Co., Ltd. (Δ∈=5.0, Δn=0.098), a liquid crystal material F prepared by Merck & Co., Ltd. (Δ∈=7.5, Δn=0.098), and a liquid crystal material G prepared by Merck & Co., Ltd. (Δ∈=11.5, Δn=0.098), respectively. The liquid crystal display panels D, E, F, and G were then each combined with each of three different backlight units used in Embodiments 1 to 3 to produce 12 types of liquid crystal display devices D-1, D-2, D-3, E-1, E-2, E-3, F-1, F-2, F-3, G-1, G-2, and G-3.

A voltage of 6 V was applied to the pixel electrode using one source line and a voltage of −6 V was applied to the counter electrode using the other source line, whereby a voltage of 12 V was applied to the liquid crystal layer. And then the difference (deviation) between a proportion of distribution of directors in the range of polar angles of from ±20° to ±60° in the entire director distribution, and a proportion of distribution of light emitted from a backlight unit in the range of polar angles of from ±20° to ±60° in the entire distribution of light emitted from a backlight unit was calculated. The calculation was performed on the thus-produced liquid crystal display devices D-1, D-2, D-3, E-1, E-2, E-3, F-1, F-2, F-3, G-1, G-2, and G-3. Table 6 summarizes deviations calculated in such a way.

TABLE 6

| | | Exam- | Exam- | Exam- | Exam- | Exam- |
|---|---|---|---|---|---|---|
| | | ination | ination | ination | ination | ination |
| | | Exam- | Exam- | Exam- | Exam- | Example |
| | | ple 1 | ple 2 | ple 3 | ple 4 | 5 |
| | L (μm) | 3 | 3 | 3 | 3 | 3 |
| | S (μm) | 2 | 3 | 6 | 8 | 12 |
| Δε = | Liquid crystal | 2.6% | 2.2% | 8.9% | 7.3% | 24.3% |
| 2.0 | display device | | | | | |
| | D-1 | | | | | |
| | Liquid crystal | 4.4% | 9.2% | 15.9% | 14.3% | 17.3% |
| | display device | | | | | |
| | D-2 | | | | | |
| | Liquid crystal | 6.6% | 1.8% | 4.9% | 3.3% | 28.3% |
| | display device | | | | | |
| | D-3 | | | | | |
| Δε = | Liquid crystal | 3.1% | 1.9% | 6.5% | 7.4% | 4.2% |
| 5.0 | display device | | | | | |
| | E-1 | | | | | |
| | Liquid crystal | 10.1% | 5.1% | 0.5% | 0.4% | 2.8% |
| | display device | | | | | |
| | E-2 | | | | | |
| | Liquid crystal | 0.9% | 5.9% | 10.5% | 11.4% | 8.2% |
| | display device | | | | | |
| | E-3 | | | | | |
| Δε = | Liquid crystal | 0.6% | 6.6% | 12.0% | 13.6% | 12.8% |
| 7.5 | display device | | | | | |
| | F-1 | | | | | |
| | Liquid crystal | 6.4% | 0.4% | 5.0% | 6.6% | 5.8% |
| | display device | | | | | |
| | F-2 | | | | | |
| | Liquid crystal | 4.6% | 10.6% | 16.0% | 17.6% | 16.8% |
| | display device | | | | | |
| | F-3 | | | | | |
| Δε = | Liquid crystal | 3.2% | 8.8% | 15.8% | 17.0% | 17.6% |
| 11.5 | display device | | | | | |
| | G-1 | | | | | |
| | Liquid crystal | 3.8% | 1.8% | 8.8% | 10.0% | 10.6% |
| | display device | | | | | |
| | G-2 | | | | | |
| | Liquid crystal | 7.2% | 12.8% | 19.8% | 21.0% | 21.6% |
| | display device | | | | | |
| | G-3 | | | | | |

As shown in Table 6, even if a liquid crystal material with relatively small dielectric anisotropy (for example, Δ∈=2.0 to 11.5), the double-source-polarity-inversion driving achieves a liquid crystal display device in which the difference (deviation) between the proportion of distribution of directors in the range of polar angles of from ±20° to ±60° in the entire director distribution, and the proportion of the distribution of light emitted from a backlight unit in the range of polar angles of from ±20° to ±60° in the entire distribution of light emitted from a backlight unit is less than 20%.

### Embodiment 5

FIG. 19 is a cross-sectional view schematically showing a configuration of a liquid crystal display device in accordance with Embodiment 5. As shown in FIG. 19, the liquid crystal display device of Embodiment 5 is provided with a liquid crystal display panel including a liquid crystal layer 13 and a pair of substrates 11 and 12 sandwiching the liquid crystal layer 13. One of the pair of substrates is a TFT substrate 11, and the other is a counter substrate 12.

The liquid crystal display device of Embodiment 5 has the same configuration as those of Embodiments 1 to 4, except that a counter electrode 65 is disposed on a counter-substrate-12 side. Specifically, as shown in FIG. 19, the counter electrode 65, a dielectric layer (insulating layer) 66, and a vertical alignment film 52 are stacked in this order on the liquid-crystal-layer-13-side main surface of a glass substrate included in the counter substrate 12. A color filter and/or a black matrix (BM) may be disposed between the counter electrode 65 and the glass substrate 32.

The counter electrode 65 is formed of a transparent conductive film such as an ITO film and an IZO film. The seamless counter electrode 65 and the seamless dielectric layer 66 are each formed at least over the entire display region. Predetermined electric potential is applied to the counter electrode 65. The electric potential is common between each pixel and each sub pixel.

The dielectric layer 66 is formed of a transparent insulating material. Specific examples of the insulating material include inorganic insulating films such as a silicon nitride film, and organic insulating films such as an acrylic resin film.

Meanwhile, similarly to Embodiment 1, a pair of comb-shaped electrodes including a pixel electrode 21 and a counter electrode 22, and a vertical alignment film 51 are disposed on the liquid-crystal-layer-13-side main surface of the glass substrate 31 included in the TFT substrate 11. Polarizers 71 and 72 are arranged on the outer main surfaces of the two glass substrates 31 and 32, respectively.

Different voltages are applied between the pixel electrode 21 and the counter electrode 22, and between the pixel electrode 21 and the counter electrode 65, during non-black display. The counter electrode 22 and the counter electrode 65 may be grounded. The same level of a voltage with the same polarity may be applied to the counter electrode 22 and the counter electrode 65. Different levels of voltages with different polarities may be applied to the counter electrode 22 and the counter electrode 65.

According to the liquid crystal display device of Embodiment 5, similarly to Embodiment 1, a high contrast ratio and excellent viewing angle characteristics can be achieved, and high transmittance can be further achieved. Response speed can be increased by forming the counter electrode 65.

FIG. 20 is a plan view schematically showing the configuration of the liquid crystal display device in accordance with Embodiment 5. The features of the configuration shown in FIG. 20 may be applied to those in Embodiments 1 to 3. A pixel may comprise a plurality of sub pixels, and in this case, the following configuration shows a sub pixel. The 3 o'clock direction, 12 o'clock direction, 9 o'clock direction, and 6 o'clock direction, when the liquid crystal display device is viewed from the front, are the 0° direction (azimuth), 90° direction (azimuth), 180° direction (azimuth) and 270° direction (azimuth), respectively, and the direction passing through the 3 o'clock and 9 o'clock is the left-right direction, and the direction passing through 12 o'clock and 6 o'clock is the up-down direction.

On the liquid-crystal-layer-13-side main surface of the glass substrate 31, signal lines 23, scanning lines 25, a common line 33, a thin film transistor (TFT) 27 that is a switching element (active element) and is formed in each sub pixel, a pixel electrode 21 separately formed in each sub pixel, and a counter electrode 22 connected with the common line 33 formed to be commonly used among a plurality of pixels (for example, all sub pixels) are disposed.

The scanning lines 25, and the common line 33, and the counter electrode 22 are formed on the glass substrate 31. A gate insulating film (not shown) is formed on the scanning lines 25, the common line 33, and the counter electrode 22. The signal lines 23 and the pixel electrode 21 are formed on the gate insulating film, and a vertical alignment film 51 is formed on the signal lines 23 and the pixel electrode 21.

The common line 33, the counter electrode 22, and the pixel electrode 21 are patterned by photolithography using the same film in the same step, and may be arranged on the same layer (the same insulating film).

The signal lines 23 are linearly arranged in parallel with each other, and extend in an up-down direction between the adjacent two sub pixels. The scanning lines 25 are linearly arranged in parallel with each other, and extend in a left-right direction between the adjacent two sub pixels. The signal lines 23 are perpendicular to the scanning lines 25. The region partitioned by the signal lines 23 and the scanning lines 25 is approximately one sub pixel. The scanning lines 25 function as a gate of the TFT 27 in a display region.

The TFT 27 is formed near the intersection portion of each of the signal lines 23 and each of the scanning lines 25, and includes a semiconductor layer 28 formed in an island shape on the scanning line 25. The TFT 27 has a source electrode 24 which functions as a source, and a drain electrode 26 which functions as a drain. The source electrode 24 connects the TFT 27 and the signal line 23, and the drain electrode 26 connects the TFT 27 and a pixel electrode group 20. The source electrode 24 and the signal lines 23 are patterned in the same film, and are connected with each other. The drain electrode 26 and the pixel electrode 21 are patterned in the same film, and are connected with each other.

A signal voltage (picture signal) is applied to the pixel electrode 21 from the signal lines 23 at predetermined timing during on-state of the TFT 27. Meanwhile, a predetermined electric potential (common voltage) is applied to the common line 33 and the counter electrode 22. The electric potential is common between each pixel.

The pixel electrode 21 has a comb-teeth shape in plan view. The pixel electrode 21 has a linear trunk portion (pixel trunk portion 45) and a plurality of linear comb-tooth portions (pixel comb-tooth portions 46). The pixel trunk portion 45 is formed along a short side (lower side) of a pixel. The pixel comb-tooth portions 46 are connected with the pixel trunk portion 45. Each of the pixel comb-tooth portions 46 extends from the pixel trunk portion 45 toward a short side (upper side) facing the pixel trunk portion 45, that is, in the about 90° direction.

The counter electrode 22 has a comb-teeth shape in plan view, and has a plurality of linear comb-tooth portions (counter comb-tooth portions 34). The counter comb-tooth portions 34 and the common line 33 are patterned in the same film, and are connected with each other. That is, the common line 33 is also a trunk portion (counter trunk portion) of the counter electrode 22 that connects the plurality of counter comb-tooth portions 34 with each other. The common line 33 is formed in a linear shape and parallel with the scanning lines 25, and extends in a left-right direction between the adjacent two sub pixels. The counter comb-tooth portions 34 extend from the common line 33 toward a lower side facing the common line 33, that is, in the about 270° direction.

Thus, the pixel electrode 21 and the counter electrode 22 are arranged to face each other so that the comb teeth of the pixel electrode 21 and the counter electrode 22 (pixel comb-tooth portions 46, counter comb-tooth portions 34) are disposed alternately and spaced apart from each other. That is, the pixel comb-tooth portions 46 and the counter comb-tooth portions 34 are arranged parallel to each other, and are spaced apart from each other and alternately arranged.

According to one example shown in FIG. 20, two domains including the respective liquid crystal molecules with opposite inclinations are formed in one sub pixel. The number of the domains is not particularly limited. In order to achieve excellent visual-angle characteristics, four domains may be formed in one sub pixel.

According to one example shown in FIG. 20, one sub pixel includes two or more regions different in electrode space. Specifically, the regions include a region with a relatively small electrode space (a region with a space of Sn) and a region with a relatively large electrode space (a region with a space of Sw). Thereby, a threshold value of VT characteristics differs between such regions. Particularly, degree of an inclination of the VT characteristics of the entire sub pixels at low gradation can become small. As a result, occurrence of white floating can be suppressed and viewing angle characteristics can be improved. The white floating refers to a phenomenon where display that ought to appear dark appears whitish when an observation direction is changed from a front direction to an oblique direction during relatively dark display at low gradation.

The present application claims priority to Patent Application No. 2009-130186 filed in Japan on May 29, 2009, Patent Application No. 2009-193031 filed in Japan on Aug. 24, 2009, and Patent Application No. 2010-006691 filed in Japan on Jan. 15, 2010 under the Paris Convention and provisions of national law in a designated State, the entire contents of which are hereby incorporated by reference.

### EXPLANATION OF NUMERALS AND SYMBOLS

1: Liquid crystal display panel
2: Backlight unit
10, 61: Liquid crystal molecule
11: TFT substrate
12: Counter substrate
13: Liquid crystal layer
14: A pair of comb-shaped electrodes
21: Pixel electrode
22: Counter electrode
23: Signal line
24: Source electrode
25: Scanning line (gate line)
26: Drain electrode
27: TFT
28: Semiconductor layer
31, 32: Glass substrate
33: Common line (counter trunk portion)
34: Counter comb-tooth portion
41: Color filter
41R: Red color filter
41G: Green color filter
41B: Blue color filter
42: Black matrix (BM)
45: Pixel trunk portion
46: Pixel comb-tooth portion
51, 52: Vertical alignment film
65: Counter electrode
66: Dielectric layer
71, 72: Polarizer
81: Reflective Sheet
82: Light source
83: Light guide plate
84: Diffusion sheet
85: First lens sheet
86: Second lens sheet
87: Third lens sheet
88: Diffuser

1. A liquid crystal display device, comprising:
a liquid crystal display panel including a liquid crystal layer and a pair of substrates sandwiching the liquid crystal layer; and
a backlight unit disposed on a back side of the liquid crystal display panel, one of the pair of substrates including a pair of comb-shaped electrodes each having comb teeth, the comb teeth of one of the pair of comb-shaped electrodes and the comb teeth of the other of the pair of comb-shaped electrodes being disposed alternately and spaced apart from each other,
the liquid crystal layer including liquid crystal molecules with positive dielectric anisotropy,
the liquid crystal molecules being aligned in a direction perpendicular to a surface of the one of the pair of substrates when no voltage is applied, and
a difference between a proportion of liquid crystal molecules aligned in directions at angles of from 20° to 60° and angles of from −60° to −20° to the surface of the one of the substrates during white display relative to all liquid crystal molecules contained in the liquid crystal layer, and a proportion of light emitted in directions at angles of from 20° to 60° and angles of from −60° to −20° to the surface of the one of the substrates relative to all light emitted from the backlight unit and entering the liquid crystal display panel being less than 20%.

2. The liquid crystal display device according to claim 1,
wherein the difference between the proportion of liquid crystal molecules aligned in directions at angles of from 20° to 60° and angles of from −60° to −20° to the surface of the one of the substrates to all liquid crystal molecules contained in the liquid crystal layer during white display, and the proportion of light emitted in directions at angles of from 20° to 60° and angles of from −60° to −20° to the surface of the one of the substrates relative to all light emitted from the backlight unit and entering the liquid crystal display panel is less than 15%.

3. The liquid crystal display device according to claim 1,
wherein the proportion of light emitted in directions at angles of from 20° to 60° and angles of from −60° to −20° to the surface of the one of the substrates relative to all light emitted from the backlight unit and entering the liquid crystal display panel is 40 to 51%.

4. The liquid crystal display device according to claim 1, comprising a source line for supplying a signal voltage to one of the pair of comb-shaped electrodes,
wherein the positive dielectric anisotropy Δ∈ is 14<Δ∈<23.

5. The liquid crystal display device according to claim 1, comprising a first source line for supplying a signal voltage and a second source line for supplying a signal voltage,
wherein a signal voltage is supplied to one of the pair of comb-shaped electrodes through the first source line, and a signal voltage is supplied to the other of the pair of comb-shaped electrodes through the second source line,
the signal voltage supplied through the first source line and the signal voltage supplied through the second source line have polarities opposite to each other, and
the positive dielectric anisotropy Δ∈ is 2.0<Δ∈<11.5.
